(19) United States
(12) Patent Application Publication
(10) Pub. No.: US 2017/0066900 A1
(43) Pub. Date: Mar. 9, 2017

(54) COMPOSITION MODIFYING THE MECHANICAL PROPERTIES OF A THERMOPLASTIC POLYMER

(71) Applicants: INSTITUT NATIONAL DE LA RECHERCHE AGRONOMIQUE - INRA, Paris (FR); CNAM - CONSERVATOIRE NATIONAL DES ARTS ET METIERS, Paris (FR); INSTITUT SCIENCES INDUSTRIES VIVANT ET ENVIRONNEMENT (AGROPARISTECH), Paris (FR); BRODART, Arcis Sur Aube (FR); INSTITUT DES CORPS GRAS, Pessac (FR)

(72) Inventors: Violette DUCRUET, Saint Remy Les Chevreuse (FR); Alexandre RUELLAN, Bourg La Reine (FR); Sandra AICHERNIG-DOMENEK, Igny (FR); Alain GUINAULT, Cregy Les Meaux (FR); Cyrille SOLLOGOUB, Clamart (FR); Carine ALFOS, Pessac (FR); Guillaume CHOLLET, Leognan (FR); Anne-Chrystelle DELAMOUR, Saint Parres Aux Tertres (FR)

(21) Appl. No.: 15/122,670

(22) PCT Filed: Mar. 4, 2015
(86) PCT No.: PCT/FR2015/050533

§ 371 Date: Aug. 31, 2016

(30) Foreign Application Priority Data
Mar. 4, 2014 (FR) 1451772

(51) Int. Cl. C08K 5/09; B65D 65/46

(52) U.S. Cl. CPC C08K 5/09; B65D 65/466; C08K 2201/018

(57) ABSTRACT

The use of a composition including at least one saturated free fatty acid and at least one unsaturated free fatty acid as additive, for modifying the mechanical properties of a thermoplastic polymer material. An additivated thermoplastic polymer material and a process for producing same are also described.

### FIELD OF THE INVENTION

The invention relates to the field of thermoplastic material additives. In particular the use relates to the use of free fatty acids, in particular in the form of a vegetable oil deodorization condensate, in order to improve the mechanical properties of thermoplastic materials. The invention also relates to a method for obtaining plastic materials with improved mechanical properties as well as to thermoplastic materials and derivative products that have said properties.

### BACKGROUND ART

Today there is an increasing concern in terms of the environment. This trend results in the substantial industrial development of biodegradable plastic materials. In parallel, with the progressive depletion of fossil resources, the development of alternative biosourced materials is also a major concern.

These materials, with a biodegradable and/or biosourced polymer base or of mixtures of biodegradable and/or biosourced polymers must however have performance that is equal or superior to the commonly used synthetic materials in order to be competitive. As such, in order to be usable on a large scale, the final formulated material must have physical properties that satisfy the requirements of industrial production and for use by consumers.

The most commonly used solution in order to improve the mechanical performance of plastic materials, and in particular the breaking elongation, also called ductility, consists in the adding to the resin of polymers, additives, also called plasticizers, for example phtalates, citrates, adipates, stearates, benzoates, epoxides, etc., that make it possible to generate a product that is flexible, resistant and easier to manipulate.

However the plasticizers currently used in the polymer industry are generally of petrochemical origin, in such a way that this additivation does not make it possible to retain the biodegradability of the product, and/or decrease the biosourced carbon content of the final material, and this all the more so that a plasticizer is usually added in high quantity (between 10 and 30% by weight with respect to the total weight of the material).

Furthermore, the adding of a plasticizer in a polymer material tends to decrease its glass transition temperature as well as various mechanical magnitudes, such as Young's modulus or the yield stress and/or the breaking stress, physical characteristics of the material that are limiting in certain applications.

Moreover, many plasticizers are toxic for humans or animals, in such a way that their use, in particular in materials intended for food contact, is subjected to strict regulations at the European level. In particular, the risks linked to the use of a chemical substance that enters into the composition of a packaging from a point of view of exposure to the consumer (migration, exposition, etc.) and of its toxicity must be evaluated very strictly. The authorized substances are then ranked in a list (the Positive List, EC regulation 1935/2004).

Epoxidized derivatives of fatty acids, such as in particular epoxidized soy oil, epoxy stearates and octyl epoxy tallate can be used as a plasticizer of PVC (poly(vinyl chloride)), or of PLA (concerning polylactic acid and polylactide in the rest of the text). However, the quantities to be implemented are substantial and their very high price substantially limits their use. Moreover, their effectiveness as plasticizers, in particular to increase the ductility of polymers, is not established. In particular, for PLA the gains in terms of breaking elongation are zero or very low (ref. 1-6), despite proportions of additives close to 15% by weight. Furthermore, such epoxidized derivatives of fatty acids are known to decompose in the presence of water and separate themselves from the PVC.

It would therefore be desirable to have non-toxic biosourced and biodegradable additives, in particular suitable for food contact, that have plasticizing properties and that make it possible to modify and, according to the applications and polymers under consideration, improve the mechanical characteristics of a thermoplastic polymer material and in particular its resistance to breaking in terms of stress or elongation. It would as such be desirable to have additives that make it possible to improve the breaking elongation (i.e.: to increase it) and/or to modify one or several of the other parameters determined in a traction test, such as breaking elongation, Young's modulus as well as the yield and breaking stresses.

In certain embodiments, it is desirable to increase the ductility of a polymer material, more preferably by not modifying, or modifying it very little, its Young modulus. Such properties are typically sought for certain polymers of which the ductility is low, such as PLA, in order to improve their resistance to impact. Indeed, these modifications make it possible to improve the processability of these polymers in the framework of methods for implementations of the bulking extrusion or blow-film extrusion type.

In other embodiments, it is preferable to decrease Young's modulus in order to obtain a less rigid and more flexible material and/or to increase the breaking elongation, in order to vary the elasticity of the material.

For certain polymers, such as PLA, of which the glass transition temperature is close to 55° C., it would also be desirable to have additives, which do not modify the glass transition temperature or which modify it very little.

In certain embodiments, in particular for PLA, it is also desirable that the intrinsic mechanical properties of the polymer material into which the additives are integrated, such as Young's modulus or the yield stress are not modified. In the case of plastics intended to be transformed into food packaging, it is suitable that the plasticized material have a glass transition temperature that is sufficiently high and far from average ambient temperatures in order to prevent any phenomenon of “thermal-gluing” of the granulates during the storage, or of the film on itself when it is wound on a coil, the commercial form of the material before it is used by the packaging industry. On the other hand, its intrinsic mechanical properties must correspond to a normal use by consumers. As such, the film must be able to withstand sufficient mechanical stresses without breaking (high breaking elongation) and must not easily undergo irreversible deformations (high yield and deformation stress) which could damage the packaging, whether concerning the aspect of preserving the food or that of the esthetics of the packaging.

Among the different biosourced and biodegradable matrices, polyesters show good potential for the manufacture of packaging materials. Polylactide and/or polylactic acid (of which the common name used in the rest of this application is PLA) are in particular retained, which are already available in the market in substantial quantities. However, although PLA has many of the requirements required of thermoplastics for packaging applications, this polymer has a low breaking elongation which limits its use.

It would therefore be particularly advantageous to have additives that allow for the obtaining of a flexible film of formulated PLA, of which the breaking elongation would be substantially improved, while still retaining a glass transition temperature that is sufficiently higher than the average ambient temperatures as well as mechanical properties (modulus and stresses) that allow for manipulation by consumers without the risk of a premature deterioration of the food packaging.

### SUMMARY OF THE INVENTION

This invention provides a technical solution to the problems identified hereinabove. Indeed, the applicant discovered that the additivation of a thermoplastic polymer material with a mixture of free fatty acids comprising at least one saturated free fatty acid and at least one unsaturated free fatty acid, in particular in the form of a vegetable oil deodorization condensate, makes it possible to modify the mechanical properties of a thermoplastic polymer material.

According to the thermoplastic polymer used, or the application concerned, such modifications can correspond to a modification of at least one of the following mechanical properties:

an increase in the ductility (preferably with little or no modification of the intrinsic characteristics of the polymer such as its Young modulus),

a decrease in Young's modulus (possibly associated with a decrease in the yield stress and/or in the breaking stress) or

an increase in the elasticity (increase in the breaking elongation more preferably without significant modification of the yield and breaking stresses).

More preferably, the glass transition temperature is not or is very little modified.

In certain embodiments, in particular for PLA, PHBV or mixtures thereof, the use according to the invention makes it possible to increase the breaking elongation of said material. In parallel the glass transition temperature is decreased very little. Such an additive makes it possible more preferably to maintain values of Young's modulus and of yield stress in ranges that are compatible with uses of the material as packaging.

Furthermore, the presence of free fatty acids as an additive in the polymer material is compatible with a use of said material in contact with food. The results of this invention demonstrate indeed, that the mixtures of free fatty acids coming from the method of deodorization, used as additives, have a migration rate less than the regulatory threshold, as such predicting good stability over time of these materials.

The use of such additives makes it possible to preserve the biodegradability of biodegradable thermoplastic polymer materials. It also makes it possible to maintain, or to increase, the proportion of biosourced compounds in thermoplastic polymer materials.

This invention as such provides for the use of a composition that comprises at least one saturated free fatty acid and at least one unsaturated free fatty acid as an additive, in order to increase the breaking elongation (A_{R}) of a thermoplastic polymer material.

The invention provides several embodiments that can be taken individually or in combination with one another.

In a preferred embodiment, the composition comprising at least one saturated free fatty acid and at least one unsaturated free fatty acid is comprised in a vegetable oil deodorization condensate. More preferably, said composition is a vegetable oil deodorization condensate.

The invention further relates to an additivated thermoplastic polymer material comprising at least one thermoplastic polymer chosen from poly(vinyl chloride), polyamides, polyesters from the polyethylene terephthalate family (PET), such as glycosylated polyethylene terephthalate (PETG) or a biodegradable polyester, characterized in that it is additivated by at least one vegetable oil deodorization condensate.

In certain embodiments, the thermoplastic polymer material comprises at least one biodegradable polyester and in particular PLA and/or PHBV.

In certain embodiments, the additivated thermoplastic material, and typically PLA, is characterized in that the mass proportion of the vegetable oil deodorization condensate ranges from 1 to 30%, in particular from 1 to 20% or from 5 to 30% by weight with respect to the total weight of said additivated thermoplastic polymer material; said material having the following mechanical properties (measured in uniaxial traction according to the standard ISO 527-2): breaking elongation ranging from 30 to 300%, Young's modulus greater than 1200 MPa, yield stress greater than 15 MPa, said material also having a glass transition temperature, measured by TMDSC (temperature modulated differential scanning calorimetry) ranging from 40 to 90° C., in particular from 45 to 55° C. at atmospheric pressure.

In certain embodiments the additivated thermoplastic material according to the invention is in the form of granulates or in the form of food packaging.

The invention also relates to a method for obtaining an additivated thermoplastic polymer material, such as described hereinabove, comprising a step of additivation of at least one thermoplastic polymer material with at least one vegetable oil deodorization condensate.

The use of a deodorization condensate according to the invention and/or the implementation of the methods of the invention is particularly advantageous as it makes it possible to take advantage of co-products from vegetable oil refining and in particular of vegetable oil deodorization, which are generally eliminated. The invention therefore describes a biosourced and biodegradable economical additive, making it possible to modify the mechanical properties of a polymer material.

The invention makes it possible to obtain a plastic material with a thermoplastic polymer base of which the mechanical properties such as ductility, rigidity (Young's modulus), elasticity and yield stress, as well as the breaking elongation, and the thermal properties (glass transition temperature) are modified. In certain embodiments, typically during the additivation of a material with a PLA base, these properties are identical or greater than those of materials obtained with known additives and in particular of petrosourced origin.

Furthermore, the use of vegetable oil deodorization condensates makes it possible, through their plasticizing but also lubricating properties, to decrease the temperatures for implementing films, allowing not only for non-negligible savings in energy, but also the implementation of the method of bulking extrusion and/or blow-film extrusion, in particular with PLA mixed or not with other polymers (such as PHBV). Indeed, the additivation with a condensate according to the invention increases the melt strength of the polymer (melt strength) and facilitates the methods of bulking or blow-film extrusion.

In other embodiments, the use of a condensate of the invention makes it possible to decrease the rigidity and to increase the flexibility (typically by decreasing Young's modulus) and/or to increase the deformation capacity (elasticity) of certain polymeric materials by modifying (in particular by increasing) the breaking elongation or modifying (in particular by decreasing) the yield stress. As such generally, the invention makes it possible to improve the processability of polymeric materials.

More preferably, the additives of the invention do not modify the glass transition temperature of the additivated polymer material or modify very little.

The invention finally relates to the products carried out using the thermoplastic polymer material according to the invention, for example food packaging.

### DETAILED DESCRIPTION OF THE INVENTION

This invention provides for the use of a composition comprising at least one saturated free fatty acid and at least one unsaturated free fatty acid, as an additive, in order to modify the mechanical properties of a thermoplastic polymer material, and for example, in order to increase breaking elongation.

The term thermoplastic polymer material means a material comprising at least one thermoplastic polymer and optionally one or several additional compounds. Additional compounds are for example coloring agents, fillers, fibers, anti-static agents, fungicides, bactericides, stabilizing agents, etc.

More preferably, a thermoplastic polymer material comprises a proportion of thermoplastic polymer of at least 50%, 60%, 70%; 80%, 85%, 90%, 95% or 99% by weight with respect to the total weight of the material.

The term additivated thermoplastic polymer material means a material comprising at least one thermoplastic polymer and at least one additive according to the invention, i.e. consisting in a mixture of free fatty acids comprising at least one saturated free fatty acid and at least one unsaturated free fatty acid. More preferably, the mixture of free fatty acids comprising at least one saturated free fatty acid and at least one unsaturated free fatty acid is in the form of vegetable oil deodorization condensate.

The thermoplastic polymer materials that can be used according to the invention include at least one thermoplastic polymer chosen from poly(vinyl chloride), polyamides (aliphatic, semi-aromatic or aromatic) or polyesters (aliphatic, semi-aromatic or aromatic).

Among the thermoplastic polyesters and co-polyesters, particular mention can be made of polyglycolic acid, polylactide (PLA), polylactic acid (PLA) or one of its copolymers, polycaprolactone (PCL), polyhydroxyalkanoates (PHAs), such as PHBV (Poly(3-hydroxybutyrate-co-3-hydroxyvalerate) and PHB (poly-3-hydroxybutyrate) poly(ethylene adipate) (PEA), polyethylene succinate (PES), polybutylene succinate (PBS), poly(butylene adipate) (PBA), poly(butylene succinate-co-adipate) (PBSA), poly(butylene adipate-co-terephthalate (PBAT), polyethylene terephthalate (PET), in particular glycosylated polyethylene terephthalate (PETG), polybutylene terephthalate (PBT), polytrimethylene terephthalate (PTT).

Among polyamides, in particular aliphatic polyamides are preferred and in particular PA11 (polyundecanamide), a biosourced polymer that can be manufactured using 11-aminoundecanoic acid (amino acid coming from castor oil).

In an embodiment, biodegradable thermoplastic polymers are preferred and in particular biodegradable polyesters and copolyesters, in particular, polyglycolic acid, polylactide (PLA), polylactic acid (PLA) and copolymers thereof, polycaprolactone (PCL), polyhydroxyalkanoates (PHA), poly(ethylene adipate) (PEA), polyethylene succinate (PES), polybutylene succinate (PBS), poly(butylene adipate) (PBA), poly(butylene succinate-co-adipate) (PBSA).

Among the PHAs, mention can be made as an example of PHBV or PHB that are biodegradable.

In certain embodiments a mixture of at least two thermoplastic polymers is used. More preferably biodegradable thermoplastic polymers are used. For example, it is possible to use a mixture of PLA and of PHAs, and more preferably a mixture of PLA and of PHBV.

Generally PLA represents from 10 to 95% and more preferably from 50 to 95% or from 60 to 90%, or even from 85 to 95% by weight, with respect to the total weight of the mixture of thermoplastic polymers.

In a particular embodiment the mixture of thermoplastic polymers contains PLA and from 5 to 5%, and more preferably 10%, by weight of a second thermoplastic polymer, such as PHBV.

Biosourced means a compound, or a material, coming from animal or plant biomass. By definition, the vegetable oil deodorization condensates according to the invention come from the plant biomass.

Biodegradable means that the polymer and in particular the polymer material can be converted into carbon dioxide or into methane, into water and into biomass under the effect of the microorganisms that use it as a nutrient. More preferably, 90% of the biodegradation must be reached in less than 6 months. Furthermore, the totality of the residues greater than 2 mm must be less than 10% of the initial mass after 3 months of fragmentation under the effect of a compost. In a particularly preferred manner, a polymer or a polymer material according to the invention meets the standard EN 13432.

The thermoplastic polymer materials of the invention and in particular the thermoplastic polymers of the invention are typically biosourced, i.e. coming from animal or plant biomass.

In a particularly preferred embodiment of the invention, polylactic acid, polylactide and/or one of the copolymers thereof are used. Due to the chiral nature of lactic acid, several forms of PLA exist: poly-L-lactide (PLLA) is the product resulting from the polymerization of L-lactide and poly-D-lactide (PDLA), produced from the polymerization of D-lactide. Polymers and/or copolymers coming from the polymerization of L-lactide and of D-lactide or from D,L-lactide can also be used. Generally, the PLA used according to the invention comes from the polymerization of the L-lactide with a minority percentage of D-lactide or meso-lactide.

The fatty acids according to the invention are natural fatty acids that have a carbon chain having from 4 to 36 carbon atoms. The term free fatty acid means that the fatty acid is not covalently bonded to another molecule. In particular, the fatty acid is not esterified. Moreover, the free fatty acids of the invention are preferably not epoxidized.

More preferably, the free fatty acids of the invention are free fatty acids coming from vegetable oils that more preferably include from 8 to 24 carbon atoms.

With regards to saturated fatty acids, the following can be mentioned by way of examples, caprylic acid (CAS No. 124-07-2), capric acid (CAS No. 334-48-5), lauric acid (CAS No. 143-07-7), myristic acid (CAS No. 544-63-8), palmitic acid (CAS No. 57-10-3), stearic acid (CAS No. 57-11-4), arachidic acid (CAS No. 506-30-9), behenic acid (CAS No. 112-85-6) and lignoceric acid (CAS No. 557-59-5). The unsaturated fatty acids according to the invention can be mono- or polyunsaturated fatty acids. Typically the unsaturated fatty acids according to the invention have between 16 and 24 carbon atoms and can be in cis or trans form. By way of examples, mention can be made of palmitoleic acid (CAS No. 373-49-9), oleic acid (CAS No. 112-80-1), erucic acid (CAS No. 112-86-7), nervonic acid (CAS No. 506-37-6), eicosenoic acid (CAS No. 5561-99-9), linoleic acid (CAS No. 60-33-3), α-linolenic acid (CAS No. 463-40-1), γ-linolenic acid (CAS No. 506-26-3), dihomo-γ-linolenic acid (CAS No. 1783-84-2), arachidonic acid (CAS No. 506-32-1), eicosapentaenoic acid (CAS No. 10417-94-4), docosahexaenoic acid (CAS No. 6217-54-5), elaidic acid (CAS No. 112-79-8), mead acid (CAS No. 20590-32-3), myristoleic acid (CAS No. 544-64-9), sapienic acid (CAS No. 14134-46-4), petroselinic acid (CAS No. 593-39-5), trans-vaccenic acid (CAS No. 693-72-1), linolelaidic acid (CAS No. 506-21-8), rumenic acid (CAS No. 1839-11-8), punicic acid (CAS No. 544-729), α-eleostearic acid (CAS No. 208-877-3), β-eleostearic acid (CAS No. 544-73-0), captilic acid (CAS No. 4337-71-7), jacaric acid (CAS No. 28872-28-8), calendic acid (CAS No. 5204-87-5), pinolenic acid (CAS No. 16833-54-8), α-parinaric acid (CAS No. 18427-44-6), paullinic acid (CAS No. 17735-94-3). Palmitic acid, oleic acid, 1-cis oleic acid and 2-cis linoleic acid are particularly preferred according to the invention.

The term at least one saturated free fatty acid and at least one unsaturated free fatty acid mean at least one type of saturated free fatty acid and at least one type of unsaturated free fatty acid. Typically the mixture of free fatty acids according to the invention, comprising at least one saturated free fatty acid and at least one unsaturated free fatty acid, contains from 10 to 90% by weight of saturated fatty acids, with respect to the total weight of the free fatty acids, and from 90 to 10% by weight of unsaturated fatty acids, with respect to the total weight of the free fatty acids.

In certain embodiments, a mixture of free fatty acids will be chosen more preferably containing at least 40% by weight of saturated free fatty acids, with respect to the total weight of the free fatty acids, and in particular from 40 to 60% or from 40 to 55% by weight of saturated free fatty acids with respect to the total weight of free fatty acids. Such an example of a mixture of free fatty acids is shown by the palm oil deodorization condensates which include a proportion of free fatty acids ranging from 40 to 55% and in particular from 40 to 50% by weight with respect to the total weight of the saturated free fatty acids (with the remaining fraction being represented by the unsaturated free fatty acids).

In certain embodiments a mixture of free fatty acids is chosen of which the iodine index is less than a value of 150, of 120, of 100, of 80, of 70 or of 60 to g for 100 g of mixture of free fatty acids. More preferably, the iodine index varies from 30 to 150 g, in particular from 40 to 100 g for 100 g of said mixture; and in certain embodiments from 40 to 80 g and more preferably from 40 to 60 g for 100 g of said mixture.

The iodine index of a deodorization condensate according to the invention corresponds to the mass of diiodine (I₂) (expressed in g) able to be fixed on the unsaturations, or double bonds, present in 100 g of condensate, and in particular on the unsaturated free fatty acids. The iodine index can be determined by the Wijs method (standard ISO EN 3961).

By way of example, a palm oil deodorization condensate according to the invention has an iodine index ranging from 52 to 57 g/100 g of deodorization condensate. An olive oil deodorization condensate has an iodine index ranging from 48 to 52 g/100 g of condensate; a rapeseed oil deodorization condensate has an iodine index ranging from 110 to 120 g and more preferably from 114 to 118 g/100 g of condensate. Finally, a sunflower oil deodorization condensate has an iodine index ranging from 130 to 140 g, more preferably from 134 to 138 g/100 g of condensate.

According to the invention, the thermoplastic polymer material can be additivated (in such a way as to obtain an additivated thermoplastic polymer material) with a mass proportion of a composition of free fatty acids according to the invention ranging from 1 to 30%, in particular from 1 to 20% and more particularly from 1 to 15% by weight, with respect to the total weight of the thermoplastic polymer additivated with said mixture of free fatty acids.

In certain embodiments, the composition of free fatty acids according to the invention comprises a mass proportion of free fatty acids ranging from 15 to 100%, in particular from 25 to 100% by weight with respect to the total weight of the composition. In certain embodiments, this mass proportion is greater than or equal to any of the following values: 20; 25; 30 35; 40; 45; 50; 55; 60; 65; 70; 75; 80; 85; 90 or 95%. A thermoplastic polymer material can therefore be additivated with a mass proportion of such a composition in mass proportions, with respect to the total weight of the additivated thermoplastic polymer ranging from 1 to 20%, in particular from 1.25 to 20%, from 5 to 20%, from 5 to 15%, in particular, in proportions of 5; 10; 15 or 20% by weight.

Such a composition can also include one or several components chosen from esterified fatty acids, such as mono-, di- or triglycerides, aldehydes, ketones, hydrocarbons (aliphatic or of terpenic origin such as squalene but also residues of aromatic polycyclic hydrocarbons), sterols, tocopherols, tocotrienols and phytosterols.

The total fatty acid content (i.e. the free fatty acids and the esterified fatty acids in particular in the form of mono-, di- or triglycerides) of a composition of free fatty acids according to the invention varies from 50 to 100% by weight with respect to the total weight of the composition, more preferably, from 65 to 100%, from 70 to 100%, from 75 to 100%, from 80 to 100%, from 85 to 100% from 90 to 100% or from 95 to 100%. More preferably also such a composition of free fatty acids comprises less than 75% of esterified fatty acids (typically in the form of glycerides), and more preferably less than 70, less than 65, less than 60, less than 50, less than 40, less than 30, less than 20 or less than 10% by weight of esterified fatty acids, with respect to the total weight of the composition. In certain embodiments, such a composition comprises less than 35% of triglycerides, in particular less than 20%, less than 15%, less than 10%, less than 5% or less than 2% by weight of triglycerides, with respect to the total weight of the composition.

In certain embodiments, the composition of free fatty acids according to the invention can include hydrogenated or partially hydrogenated vegetable oil. More preferably such a composition comprises less than 40%, or, less than 20, less than 15, less than 10 or less than 5% by weight of hydrogenated or partially hydrogenated vegetable oil, with respect to the total weight of the composition of free fatty acids.

In a particularly preferred embodiment of the invention, the composition of free fatty acids, such as described hereinabove, is in the form of a vegetable oil deodorization condensate. More particularly, the composition of free fatty acids, such as described hereinabove, is a vegetable oil deodorization condensate.

The term vegetable oil means according to the invention, an oil obtained by extraction using a plant product. According to the invention for example, deodorization condensates can be used obtained from soy oil, olive oil, palm oil, rapeseed oil, peanut oil, almond oil, sunflower oil, oleic sunflower oil, palm kernel oil, grape seed oil, pumpkin seed oil, corn oil, walnut oil, wheat germ oil, borage oil, hazelnut oil, cameline oil, hemp oil, macadamia oil, primrose oil. In certain embodiments deodorization condensates of two, or more, different vegetable oils can be used.

Preferably, according to the invention deodorization condensates (or deodorization distillate) are used obtained by refining at least one oil chosen from the group comprising soy oil, olive oil, palm oil, rapeseed oil, peanut oil, palm kernel oil, sunflower oil, grape seed oil, oleic sunflower oil or corn oil and in particular soy oil, olive oil, palm oil and rapeseed oil. In a particular embodiment a deodorization condensate is used, such as obtained during the refining of palm oil.

The deodorization of an oil, typically during the physical refining of an oil, proceeds via distillation of fatty acids at high temperature and in a high vacuum, with injection of steam (making it possible to carry out the steam distillation of the distilled compounds) in equipment of the deodorizer type, provided with a condenser in order to recover the fatty acids that distill. The mixture of compounds with the oil removed via steam distillation is called a deodorization condensate. Such a distillation with injection of dry steam makes it possible to eliminate via steam distillation, in addition to the fatty acids, several other compounds such as for example odoriferous substances (typically aldehydes or ketones). The oil obtained after refining and in particular after the step of deodorization, is an oil without odor or unpleasant taste, of a light color, slightly acidic and non-peroxided.

The different steps of a chemical refining are typically:

water degumming or acid conditioning. The by-products obtained are gums containing phospholipids

chemical neutralization with soda (obtaining of neutralization pastes)

washings and drying (obtaining of washing water)

the step of discoloring (obtaining of decolorizing earths)

the step of deodorization (obtaining of deodorization condensates)

In the case of a physical refining, the steps are generally limited to:

the step of water degumming or acid conditioning.

the step of discoloring (obtaining of decolorizing earths)

the step of deodorization also called deacidification or distillation (obtaining of deodorization condensates).

Methods of chemical and physical refining and in particular the steps of deodorization that make it possible to obtain a condensate that can be used in the framework of this invention are in particular described in “Manuel des Corps Gras”, by A. Karleskind (Tec and Doc Lavoisier, 1992).

Generally a condensate (or distillate) of deodorization according to the invention is obtained during a step of deodorization the refining of a vegetable oil (also called deacidification in physical refining).

The deodorization, carried out via steam distillation, can be implemented in the following conditions: a temperature range ranging from 180 to 230° C. in the framework of a chemical refining or from 240 to 260° C. during a physical refining; under an absolute pressure less than 5 mbar, and generally ranging from 3 to 4 mbar for chemical refining and from 2 to 3 for physical refining (the term absolute pressure means the pressure measured with respect to a vacuum representing absolute zero pressure); with the vegetable oil being agitated with a quantity of injected steam ranging preferably from 6 to 10 kg/h, in particular from 7.5 to 8.5 kg/h. The flow rate of the steam allows for an optimum agitation of the oil. According to the type of device, the quantity of steam injected can vary from 15 to 100 kg/tonne of oil to be deodorized. The duration of the step of deodorization is according to the oil refined; the residence time at the deodorization temperature typically varies from 2 to 4 hours.

As indicated hereinabove, a vegetable oil deodorization condensate obtained via steam distillation, during physical or chemical refining (in particular during a method of refining such as described hereinabove) of an oil that can be used according to the invention, contains a mass proportion of free fatty acids ranging from 15 to 100%, more preferably from 25 to 100% by weight with respect to the total weight of the condensate. Typically it contains, in addition to the fatty acids, a mixture of compounds which are also with the oil removed with the free fatty acids, during the deodorization of the oil. In particular, such a condensate can contain, in variable proportions, one or several compounds chosen from esterified fatty acids, aldehydes, ketones, hydrocarbons (aliphatic or of terpenic origin such as squalene but also residues of aromatic polycyclic hydrocarbons), sterols, tocopherols, tocotrienols and phytosterols.

The applicant discovered in this invention, that the complex mixture of the various compounds forming the deodorization condensate of a vegetable oil had a synergistic effect on the improvement of the mechanical properties of the thermoplastic polymer material and in particular on the increase of the breaking elongation of said thermoplastic polymer material, with respect to a composition containing only a mixture of an unsaturated free fatty acid and of a saturated free fatty acid.

Preferably, the physical refining, which makes it possible to obtain a free fatty acid content greater than that of the chemical refining, is used according to the invention.

Typically, a palm oil deodorization condensate that can be used according to the invention is obtained by physical refining. It contains a mass proportion of at least 90% by weight of free fatty acids with respect to the total weight of the condensate. Typically in such a deodorization condensate, palmitic acid represents at least 40% by weight with respect to the total weight of total fatty acids (free and esterified as described hereinabove) and in particular from 40 to 55%, oleic acid at least 30% and in particular from 30 to 40%, and linoleic acid at least 5% and in particular from 5 to 10%. Such a palm oil deodorization condensate contains less than 7% of mono- di- and triglycerides, in particular less than 5% by weight with respect to the total weight of the condensate.

Typically, an olive oil deodorization condensate that can be used according to the invention is obtained by physical refining, it contains a mass proportion of at least 35% by weight, of free fatty acids, with respect to the total weight of the condensate. Typically in such a deodorization condensate, oleic acid represents at least 60%, by weight, with respect to the total weight of the total fatty acids and in particular from 60 to 75%; palmitic acid at least 10% and in particular from 10 to 15% by weight, with respect to the total weight of the total fatty acids; and linoleic acid at least 8% and in particular from 8 to 15%, by weight, with respect to the total weight of the total fatty acids. Such an olive oil condensate contains less than 60% of mono, di and triglycerides, in particular less than 50%, by weight, with respect to the total weight of the condensate. It can also contain a mass proportion of sterols ranging from 0.5 to 3%, by weight, with respect to the total weight of the condensate.

Typically, a soy oil deodorization condensate that can be used according to the invention is obtained by physical refining, it contains a mass proportion of at least 40% by weight of free fatty acids with respect to the total weight of the condensate. Typically in such a deodorization condensate, linoleic acid represents at least 45%, by weight, with respect to the total weight of the total fatty acids and in particular from 45 to 55%; oleic acid at least 18% and in particular from 18 to 25%, by weight with respect to the total weight of the total fatty acids, and palmitic acid at least 10% and in particular from 10 to 16%, by weight, with respect to the total weight of the total fatty acids. Such a palm oil condensate contains less than 35% of mono, di and triglycerides, in particular less than 30% by weight with respect to the total weight of the condensate. It can also contain a mass proportion of hydrocarbons (comprising squalene) ranging from 5 to 15% by weight with respect to the total weight of the condensate.

Typically, a rapeseed oil deodorization condensate that can be used according to the invention is obtained by physical refining, it contains a mass proportion of at least 65% by weight of fatty acids with respect to the total weight of the condensate. Typically in such a deodorization condensate, linoleic acid represents at least 35% by weight with respect to the total weight of total fatty acids and in particular from 35 to 45%; oleic acid at least 20% and in particular from 20 to 30%, by weight, with respect to the total weight of the total fatty acids, and palmitic acid at least 5% and in particular from 5 to 15%, by weight, with respect to the total weight of the total fatty acids.

The content in fatty acid of a vegetable oil deodorization condensate can be determined according to the standard NF EN ISO 12966-2. The glyceride composition can be determined according to the standard and NF EN 14105 and/or according to the standard methods for the analysis of oils, fats and derivatives, IUPAC 6.002. The composition in fatty acid can be determined according to the standard ISO 12966-2.

The use according to the invention of vegetable oil deodorization condensates as additives is advantageous, as it makes it possible to valorize co-products from the refining of vegetable oils, which are generally eliminated as refining waste. The use of vegetable oil deodorization condensates as plasticizing additives, in order to modify the mechanical properties and more preferably in order to increase the ductility of a thermoplastic polymer material, is therefore particularly economical, as contrary to prior art it does not require a dedicated step of chemical synthesis or purification in order to produce the additive.

Indeed, in the invention, the co-products of the physical or chemical refining can be used directly as plasticizing additives of polymer materials and induce an improvement of the mechanical properties of said polymer materials, in particular an increase in ductility. Such an improvement is at least of the same order of magnitude, as that obtained with conventional plasticizing additives of the adipate type (for example dioctyl adipate or DOA CAS No. 123-79-5), of the citrate type (for example acetyl tributyl citrate or ATBC CAS No. 77-90-7), or of the poly(ethylene glycol) type (for example PEG 400 CAS No. 25322-68-3), in particular for contents less than 20% and in particular less than 15%.

The use of compositions of free fatty acids, such as defined in this invention, as additives of thermoplastic polymer material, in particular the use of vegetable oil deodorization condensates described, is compatible with applications in the food field of additivated polymer materials (i.e. polymer mixtures plus additives) obtained. Indeed, according to the global migration tests of EU regulations (EU Regulation No. 10/2011 of the Commission of Jan. 14, 2011 concerning materials and objects made of plastic material intended to come into contact with items of food) for three food simulants, products carried out using the additivated polymer materials of the invention, in particular using additivated PLA (i.e. material with a polylactic acid or polylactide acid) according to the invention more preferably have an additive migration rate (constituted by the compounds of the mixture of free fatty acids according to the invention) less than or equal to 60 mg/kg of food.

The additive according to the invention as such makes it possible to modify the mechanical properties of a thermoplastic polymer material. The modifications obtained are according to the additivated thermoplastic polymer, and are as such used according to the application concerned (packaging, etc.).

Such modifications can correspond to a modification of at least one of the following mechanical properties:

an increase in the ductility (preferably with little or no modification of the intrinsic characteristics of the polymer such as Young's modulus),

a decrease in Young's modulus (possibly associated with a decrease in yield stress and/or breaking stress),

an increase in the breaking elongation (more preferably without significant modification of the yield and breaking stresses).

The breaking elongation (noted as A or A_{R}%) is a characteristic defining the capacity of a material to be extended before breaking when it is stressed in traction. A_{R} (%) is determined by a uniaxial traction trial, in particular according to the standard ISO 527-2.

The breaking elongation, or deformation at the yield threshold (A_{E}%), corresponds to the minimum deformation that generates an irreversible deformation of the material, without breaking the material.

Young's modulus (E), or elastic modulus (longitudinal) or also traction modulus, is the constant that links the traction stress (or compression stress) and the beginning of the deformation of an isotropic elastic material. It is expressed in MPa.

These parameters, as well as the values for yield stress (σ_{E}) or breaking stress (σ_{R}), can be measured by a uniaxial traction test, according to the standard ISO 527-2.

The term increasing the breaking elongation means that the breaking elongation of the additivated polymer material is at least 1.5 times, at least 3 times, at least 4 times, at least 5 times, at least 10 times, at least 15 times, at least 20 times or at least 30 times greater than the breaking elongation of the non-additivated material by the composition in free fatty acids of the invention and in particular by a vegetable oil deodorization condensate according to the invention.

An increase of the breaking elongation by least 1.5 times and in particular by at least 1.8 times can be for example obtained with a polymer of the PHA type, such as PHBV.

In certain embodiments, and particular with PLA, the use of a vegetable oil deodorization condensate according to the invention as an additive makes it possible to obtain an additivated thermoplastic polymer material, that has a breaking elongation at least equal to 20% and in particular at least equal to 30%, more particularly at least equal to 55%. In certain embodiments, the breaking elongation, obtained for an additivated thermoplastic polymer material according to the invention, such as additivated PLA, is at least equal to 130%. Such results are typically obtained during the use, in mass proportions of 10 or 15%, of deodorization condensates, or of a mixture of free fatty acids according to the invention, wherein the content of free fatty acids is at least equal to 90%. By way of example it is at least 180% for an additivated PLA material of 15% by weight of palm oil deodorization condensate with respect to the total weight of the additivated material. In such embodiments, the invention makes it possible to obtain an additivated thermoplastic polymer material, and typically additivated PLA, of which the breaking elongation ranges from 30 to 300% and in particular from 50 to 300%. In certain embodiments, the additivation of a thermoplastic polymer material with the mixture of free fatty acids, generally in the form of a composition of free fatty acids and in particular comprised in a vegetable oil deodorization condensate, and more preferably consisting in a vegetable oil deodorization condensate, such as defined hereinabove, does not modify the value of Young's modulus of said polymer material or modifies it very little.

The term “does not modify . . . or modifies it very little” means that the decrease in the value of Young's modulus, subsequent to the additivation of the polymer material with the mixture of free fatty acids according to the invention, is less than or equal to 40%, in particular less than or equal to 35%, 30%, 25%, 20% or 15%. In particular, in certain embodiments, the additivation of a thermoplastic polymer material, such as in particular PLA, PHBV, or mixtures thereof, with the mixture of free fatty acids according to the invention makes it possible to obtain an additivated thermoplastic polymer material, and in particular additivated PLA, additivated PHBV or an additivated PLA/PHB mixture, of which Young's modulus is greater than 1100 MPa in particular for PLA or PLA/PHBV mixtures (with the PLA having the majority), or greater than 750 MPa for additivated PHBV.

For the purposes of comparison, the use of ATBC, in a quantity sufficient (15% by weight) to generate a significant improvement in the breaking elongation, causes Young's modulus to drop to 270 MPa for PLA.

For example the use of condensate of a mixture of free fatty acids according to the invention makes it possible to obtain additivated PHBV of which Young's modulus is not modified by more than 10%.

On the other hand, the invention makes it possible to obtain additivated PHBV of which the breaking elongation is increased by at least 60%, and more preferably by at least 80%, and of which Young's modulus is not modified by more than 10%. For such a material, the value of Young's modulus is generally greater than 500 MPa, in particular greater than 600 MPa, and typically greater than 700 MPa. Such results are more preferably obtained with a mass proportion of a mixture of free fatty acids of the invention (typically a deodorization condensate) of 10%.

In certain embodiments, and typically for materials with a PLA (as a single polymer or with the majority) and/or PHBV base, the additivation of a thermoplastic polymer material with the mixture of free fatty acids, generally in the form of a composition of free fatty acids and in particular comprised in a vegetable oil deodorization condensate such as defined hereinabove, maintains the value of the yield stress at least at 20% and more preferably at least 25%, more preferably 30%, of the initial value of the yield stress of the polymer or of the non-additivated polymeric material.

In particular, the additivation of a thermoplastic polymer material with the mixture of free fatty acids according to the invention makes it possible to obtain an additivated thermoplastic polymer material, and in particular additivated PLA, of which the yield stress is greater than 20 MPa. It also makes it possible to obtain additivated PHBV of which the yield stress is greater than 16, which is a modification of less than 8%.

In certain embodiments the additivation of a polymer material with a mixture of free fatty acids according to the invention makes it possible to obtain an additivated polymer material of which the breaking (or deformation) elongation (A_{E}) is increased preferably by a factor of 2, in particular by a factor of 5, and preferably by a factor of 8 or by a factor of 9. Typically such an additivated material is obtained with polyamides, such as PA11. Generally it is also observed that the yield stress of such an additivated material is not significantly modified (modification less than 0.5%). By way of example for additivated PA11 (typically with a mass proportion of 10% of additive according to the invention), a yield stress of about 30 to 40 MPa (in particular from 34 to 35 MPa for PA11 additivated with a palm oil deodorization condensate) is retained while the breaking elongation of the PA11 is increased by at least a factor of 8.

Finally, in certain embodiments, the use of an additive according to the invention makes it possible to decrease the Young's modulus of a polymer material, such as PHB. As such a decrease ranging from 20 to 40%, more preferably from 25 to 35% of Young's modulus is obtained. Such a decrease makes it possible to increase the flexibility (or decrease the rigidity) of the polymer material. Possibly, in such embodiments, a decrease in the yield stress and/or in the breaking stress ranging from 15 to 25% can be obtained.

According to the invention, the ductility, or breaking elongation, Young's modulus, the yield stress and the breaking elongation can be measured according to the standard ISO 527-2 (describing in particular the use of shouldered specimens of the 5A type of a thickness of about 1 mm; a prior conditioning before study of 72 h at 23° C. under 50% relative humidity; a traction speed of 5 mm/min or of 25 mm/min as well as a temperature of 23° C. and a relative humidity of 50% during the measurement).

Generally, the additivation of a thermoplastic polymer material with the mixture of free fatty acids generally in the form of a composition of free fatty acids and in particular comprised in a vegetable oil deodorization condensate, such as defined hereinabove, does not modify or modifies very little the glass transition temperature (Tg) of the thermoplastic polymer material. The glass transition temperature characterizes the temperature below which the polymer material is in a vitreous state (solid). Beyond this temperature, the polymer material softens and becomes rubbery, which limits its use. The glass transition temperature can be measured according to the invention via temperature modulated differential scanning calorimetry (TMDSC), with a heating speed of 2° C./min, a temperature modulation amplitude of 0.318° C. and a modulation period of 60 s. The measurements are usually taken under a nitrogen atmosphere at 50 ml/min.

The term “does not modify or modifies very little” the glass transition temperature, means the additivation of a thermoplastic polymer material with a composition of fatty acid according to the invention decreases the glass transition temperature by less than 15° C., in particular less than 10° C., or less than 6° C.

The invention also relates to an additivated thermoplastic material comprising at least one additivated thermoplastic polymer by a mixture of free fatty acids such as defined hereinabove. In certain embodiments, the thermoplastic material comprises as a single additive a mixture of free fatty acids according to the invention.

Such an additivated polymer according to the invention has modified mechanical properties. These mechanical properties, in particular resistance to breaking make it possible in particular to improve the processability of the polymer material. For example the additivation of certain polymers such as PLA, PHBV or mixtures thereof, allows them to be implemented in methods of bulking extrusion or of blow-film extrusion. Typically such an additivated polymer according to the invention has a breaking elongation (ductility) increased by at least 1.5 times.

In certain embodiments, the invention makes it possible to obtain a polymer material, in particular additivated PHB, of which Young's modulus is reduced by at least 30%, without modification to the other mechanical properties of said polymer, such as the breaking elongation or the breaking elongation.

In certain further embodiments, the additivated polymer material has an increase in the breaking elongation that makes it possible to increase its elasticity.

Preferably, the thermoplastic polymer material comprises at least one thermoplastic polymer chosen from poly(vinyl chloride), polyamides (in particular PA11) polyesters from the family of polyethylene terephthalates and in particular glycosylated polyethylene terephthalate (PETG), or biodegradable polyesters and in particular polyesters from the family of polyhydroxyalcanoates (PHAs) such as PHB or PHBV.

In a preferred embodiment, the thermoplastic polymer is biodegradable, in particular it is a biodegradable polyester, such as PLA, PHB or PHBV. More preferably the biodegradable polymer is PLA (polylactic acid or polylactide) or PHBV.

In certain embodiments of the invention, a mixture of thermoplastic polymers is used. For example a mixture of PLA and of PHBV can be used. More preferably the mass proportion of the PLA with regards to the total weight of the mixture of polymers varies from 50 to 95%, in particular from 85 to 95%. Typically, the mass proportion of PLA in the mixture of polymer is 90%.

Preferably the composition of free fatty acids is comprised in a vegetable oil deodorization condensate. More preferably said composition of free fatty acids is a vegetable oil deodorization condensate. Deodorization condensates that are particularly adapted to the invention are palm, soy rapeseed, olive or sunflower deodorization condensates, in particular such as defined hereinabove.

The additivated thermoplastic polymer material can include a proportion of a composition of free fatty acids according to the invention and in particular of a vegetable oil deodorization condensate, ranging from 1 to 20%, in particular from 1.25 to 20%, from 5 to 20%, or from 5 to 15% by weight with respect to the total weight of the material thermoplastic polymer additivated with said mixture of free fatty acids.

Preferably the mixture of free fatty acids is comprised in a vegetable oil deodorization condensate, or is a vegetable oil deodorization condensate.

In a particular embodiment of the invention, a thermoplastic polymer material such as additivated PLA according to the invention, such as defined hereinabove, has the following mechanical properties: a breaking elongation ranging from 30 to 300%, a Young's modulus greater than 1200 MPa, a yield stress greater than 15 MPa.

In certain embodiments a thermoplastic polymer material such as additivated PHBV according to the invention has the following mechanical properties: a breaking elongation greater than 4%, a Young's modulus greater than 700 MPa and a yield stress greater than 15 MPa.

Finally, in certain embodiments, additivated polymer materials of the invention, such as polyamides and in particular PA11, have a breaking elongation greater than 60%, in particular ranging from 60 to 75% and a Young's modulus less than 400 MPa, in particular ranging from 250 to 400 MPa.

An additivated polymer material according to the invention, and in particular additivated PLA, is more preferably characterized by a glass transition temperature ranging from 35 to 90° C., in particular from 38 to 90° C., in particular from 40 to 90° C., in particular from 45 to 90° C., from 45 to 80° C., from 45 to 70° C., from 45 to 60° C., from 45 to 55° C. or from 48 to 55° C. at atmospheric pressure (i.e. about normal atmosphere). Generally, the glass transition temperature of an additivated material according to the invention is greater than 30, in particular greater than 35° C. and in particular greater than 38° C., more preferably greater than 40° C. and further more preferably greater than 45° C. or 48° C.

The mechanical properties described in the invention (breaking elongation, Young's modulus, elongation at yield and yield stress) are all measures in uniaxial traction according to the standard ISO 527-2. The glass transition temperature is measured by TMDSC (temperature modulated differential scanning calorimetry) in the conditions described hereinabove.

In an embodiment of the invention, the thermoplastic polymer material is in the form of granulates or of a film. The granulates can be stored before being transformed into a final product, in particular into a film and typically, into a film that can be used as a food packaging.

The thermoplastic polymer material of the invention can also be in the form of a packaging, for example a food packaging.

Preferably a packaging according to the invention is biosourced and/or biodegradable. For example a bag made of a plastic material, or a plastic film can be carried out with a base of additivated granulates of the invention or with a thermoplastic polymer material of the invention.

For example, the thermoplastic polymer material of the invention can also be in the form of a flexible film of PLA additivated with a composition of free fatty acids such as described in the application. In a preferred embodiment, such additivated PLA according to the invention has a breaking elongation ranging from 20 to 300%, in particular from 30 to 300% and from 55 to 300%, a Young's modulus greater than 1200 MPa, and a yield stress greater than 15 MPa, in particular greater than 45 MPa (with these parameters being measured according to the standard ISO 527-2), of which the glass transition temperature is greater than or equal to 38° C., more preferably greater than or equal to 45° C., and in particular varies from 45 to 55° C., said film comprising a mass proportion of a deodorization condensate ranging from 5 to 20%, in particular from 5 to 30% by weight, with respect to the weight of the film.

The materials and packaging according to the invention are stable over time. In particular, their glass transition temperature is stable and varies from less than 10, in particular less than 5, or even less than 3° C. over time (in particular over a period of at least 5 months and more preferably of at least 9 months).

This invention also relates to a method of manufacturing a thermoplastic polymer material such as defined hereinabove, characterized in that it comprises a step of additivation (or of mixing) of at least one thermoplastic polymer material with a mixture of free fatty acids, such as defined hereinabove.

In a preferred embodiment, the composition of free fatty acids is comprised in a vegetable oil deodorization condensate according to the invention.

In an embodiment, the step of additivation of the thermoplastic polymer material is carried out by compounding and allows for the obtaining of powder or of granulates (compounds) via single-screw extrusion coupled or not coupled to static mixers, or via two-screw extrusion with conical screws or co-rotating or counter-rotating screws, with driving or non-driving screws, with profiles interpenetrated or not, or by internal mixer. The compounding for the obtaining of granulates is a method of extrusion-granulation allowing for the melt blending of a thermoplastic polymer material with one or several additives and in particular according to the invention, with at least one mixture of free fatty acids such as defined hereinabove. It makes it possible to obtain an additivated polymer material, forming a plastic material in the form of granulates with their own physical or thermal characteristics. The compounding is generally carried out by a conventional two-screw extruder more preferably provided with co-rotating driving interpenetrated screws. Where applicable, the additivated thermoplastic polymer material has in particular a breaking elongation at least 3 times greater than that of the non-additivated polymer material with a composition of fatty acid according to the invention as described hereinabove. As also described, in certain embodiments, Young's modulus and the glass transition temperature are not modified or are modified very little.

Generally, it has been observed according to the invention that the additivation of a thermoplastic polymer, or of a mixture of thermoplastic polymers, with mixtures of free fatty acids, such as defined in this application, improves the processability of the additivated polymers obtained. In particular, these polymers, or these mixtures of polymers, can for example be formed easily in methods of thermocompression, extrusion cast or blow-film extrusion. It has in particular been observed that the blow-film extrusion method of PLA or PLA/PHBV materials cannot be implemented on non-additivated polymers.

As such, in certain embodiments, the method according to the invention comprises an additional step of forming granulates via a conventional single-screw or two-screw extruder for the obtaining of films, carrying out a flat die extrusion then a calendering or a cast or a blow-film extrusion, and making it possible to obtain films using additivated granulates of the invention.

Alternatively, the obtaining of film can be carried out in a single step according to two different methods:

carrying out of the film by any type of two-screw extrusion for the additivation coupled to a gear pump and a flat die and a calendering or casting unit or a blow-film die coupled to a blow-film unit,

carrying out of the film via single-screw extrusion for the additivation with a three-zone mixing screw coupled or not coupled to static mixers and a flat die and a calendering or casting unit or a blow-film die coupled to a blow-film unit.

The invention also relates to materials, granulates and films obtained according to the methods described hereinabove.

### FIGURES

FIG. 1: 1A: diagram showing the value of breaking elongation (%) for the additivated PLA from left to right of ATBC, DOA, PEG 400 (petrosourced additives), palm oil and olive oil deodorization condensate (biosourced additives according to the invention) in mass proportions of (for each group from left to right) 0, 5, 10 and 15%; 1B: diagram showing the value of Young's modulus to (MPa) for the additivated PLA from left to right of ATBC, DOA, PEG 400 (petrosourced additives), palm oil and olive oil deodorization condensate (biosourced additives according to the invention) in mass proportions of (for each group from left to right) 0, 5, 10 and 15%; 1C: diagram showing the value of the yield stress (MPa) for the additivated PLA from left to right of ATBC, DOA, PEG 400 (petrosourced additives), palm oil and olive oil deodorization condensate (biosourced additives according to the invention) in mass proportions of (for each group from left to right) 0, 5, 10 and 15%.

FIG. 2: 2A diagram showing the value of the glass transition temperature (Tg in ° C.) for the additivated PLA from left to right of ATBC, DOA, PEG 400 (petrosourced additives), palm oil and olive oil deodorization condensate (biosourced additives according to the invention) in mass proportions of (for each group from left to right) 0, 5, 10 and 15%; 2B: Comparison of the glass transition temperature (Tg) at 20 (light gray) and 170 days (dark gray) of PLA additivated with a palm oil deodorization condensate in mass proportions (from left to right) of 0, 5, 10, 15 or 20% by weight with respect to the total weight of the mixture. 2C: Comparison of the glass transition temperature (Tg) at 10 (light gray) and 290 days (dark gray) of PLA additivated with an olive oil deodorization condensate (2C) in mass proportions (for each one of the 5 groups from left to right) of 0, 5, 10, 15 or 20% by weight with respect to the total weight of the mixture.

FIG. 3: 3A-D diagrams showing the value of breaking elongation (%) (3A), the value of Young's modulus (MPa) (3B), the value of the yield stress (MPa) (3C) and the glass transition temperature (Tg in ° C.) (3D) for the additivated PLA from left to right of palm, olive, rapeseed oil deodorization condensate and in mass proportions of (for each group from left to right) 0, 5, 10 and 15%.

FIG. 4: 4A-D diagrams showing the value of breaking elongation (%) (4A), the value of Young's modulus (MPa) (4B), and the glass transition temperature (Tg in ° C.) (4C) for the non-additivated PLA (composition 1) or additivated with different formulations of free fatty acids (compositions 2 to 7)

### EXAMPLES

Equipment and Methods:

The examples of deodorization condensates used in the experimental results described hereinafter were recovered during the step of deodorization of a method for the physical refining of olive, soy, rapeseed, palm or sunflower oil.

The step of deodorization was carried out in the following conditions: a temperature between 240 and 260° C., an absolute pressure less than 5 mbar, a duration between 2 and 3 h and with a quantity of injected steam of about 8 kg/h. The composition of the oil deodorization condensates obtained was analyzed using gas chromatography.

These condensates have a great variability in their composition in fatty acids. They are described for the purposes of illustration and the results show that the presence of a mixture of saturated and unsaturated free fatty acids, regardless of the exact composition in fatty acids makes it possible to obtain an improvement in the ductility of the polymer tested.

1) Soy oil condensates: average composition

| Analysis | Results | | Unit | Method |
|---|---|---|---|---|
| Acid index | 68.43 | | mg KOH/g | NF EN ISO |
| | | | | 660 |
| Saponification | 157.9 | | mg KOH/g | NF EN ISO |
| index | | | | 3657 |
| Fatty acid | 76 | | g/100 g of | NF EN ISO |
| content | | | product | 12966-2 |
| Glyceride | Free fatty | 43.08 | % | IUPAC |
| composition | acids | | | 6.002 and |
| | Mono | 2.92 | % | NF EN |
| | glycerides | | | 14105 |
| | Cholesterol | 1.05 | % | |
| | Sterols | 8.69 | % | |
| | Di glycerides | 8.96 | % | |
| | Tri glycerides | 16.84 | % | |
| | Squalene + | 13.78 | % | |
| | hydrocarbons | | | |
| | Unidentified | 4.59 | % | |

Composition in fatty acids (NF EN 12966-2)

| | FATTY ACID | Usual name | % |
|---|---|---|---|
| | C12:0 | Lauric acid | 0.8 |
| | C14:0 | Myristic acid | 0.4 |
| | C16:0 | Palmitic acid | 12.3 |
| | C18:0 | Stearic Acid | 4.1 |
| | C18:1 cis | Oleic Acid | 21.7 |
| | C18:2 cis | Linoleic Acid | 49.7 |
| C18:3 trans | | | 0.4 |
| | C18:3 cis | Linolenic Acid | 6.0 |
| | C20:0 | Arachidic Acid | 0.3 |
| | C20:1 | Eicosenoic Acid | 0.2 |
| | C22:0 | Behenic Acid | 0.5 |
| | C24:0 | Lignoceric Acid | 0.2 |

| | |
|---|---|
| unidentified | 3.4 |

2) Palm oil condensate: average composition

| Analysis | Results | | Unit | Method |
|---|---|---|---|---|
| Acid index | 201.03 | | mg KOH/g | NF EN ISO |
| | | | | 660 |
| Saponification | 205.7 | | mg KOH/g | NF EN ISO |
| index | | | | 3657 |
| Fatty acid | 100 | | g/100 g of | NF EN ISO |
| content | | | product | 12966-2 |
| Glyceride | Free fatty | 95.37 | % | IUPAC |
| composition | acids | | | 6.002 and |
| | Mono | 1.66 | % | NF EN |
| | glycerides | | | 14105 |
| | Cholesterol | 0 | % | |
| | Sterols | 0 | % | |
| | Di glycerides | 2.24 | % | |
| | Tri glycerides | 0.65 | % | |
| | Fatty acid | 0 | % | |
| | esters | | | |
| | Unidentified | 0 | % | |

Composition in fatty acids (NF EN 12966-2)

| | FATTY ACID | Usual name | % |
|---|---|---|---|
| | C12:0 | Lauric acid | 0.4 |
| | C14:0 | Myristic acid | 1.3 |
| | C16:0 | Palmitic acid | 49.8 |
| | C16:1 | Palmitoleic acid | 0.2 |
| | C18:0 | Stearic Acid | 4.1 |
| C18:1 trans | | | 0.2 |
| | C18:1 cis | Oleic Acid | 35.0 |
| C18:2 trans | | | 0.1 |
| | C18:2 cis | Linoleic Acid | 7.7 |
| | C18:3 cis | Linolenic Acid | 0.3 |
| | C20:0 | Arachidic Acid | 0.3 |
| | C20:1 | Eicosenoic Acid | 0.1 |

| | |
|---|---|
| unidentified | 0.7 |

3) Rapeseed oil condensate: average composition

| Analysis | Results | Unit | Method |
|---|---|---|---|
| Acid index | 65.29 | mg KOH/g | NF EN ISO |
| | | | 660 |
| Saponification | 125.1 | mg KOH/g | NF EN ISO |
| index | | | 3657 |
| Fatty acid | 67.6 | g/100 g of | NF EN ISO |
| content | | product | 12966-2 |

Composition in fatty acids (NF EN ISO 12966-2):

| | FATTY ACID | Usual name | % |
|---|---|---|---|
| | C16:0 | Palmitic acid | 7.4 |
| | C18:0 | Stearic Acid | 3.4 |
| | C18:1 cis | Oleic Acid | 27.3 |
| | C18:2 cis | Linoleic Acid | 41.7 |
| C18:3 trans | | | 0.7 |
| | C18:3 cis | Linolenic Acid | 1.5 |
| | C20:0 | Arachidic Acid | 0.5 |
| | C20:1 | Eicosenoic Acid | 0.3 |
| | C22:0 | Behenic Acid | 1.0 |
| | C24:0 | Lignoceric Acid | 0.5 |

| | |
|---|---|
| unidentified | 15.9 |

4) Olive oil condensate: average composition

| Analysis | Results | | Unit | Method |
|---|---|---|---|---|
| Acid index | 47.73 | | mg KOH/g | NF EN ISO |
| | | | | 660 |
| Saponification | 162.2 | | mg KOH/g | NF EN ISO |
| index | | | | 3657 |
| Fatty acid | 79.3 | | g/100 g of | NF EN ISO |
| content | | | product | 12966-2 |
| Glyceride | Free fatty | 39.24 | % | IUPAC |
| composition | acids and | | | 6.002 and |
| | associated | | | NF EN |
| | compounds | | | 14105 |
| | Mono | 15.05 | % | |
| | glycerides + | | | |
| | squalene | | | |
| | Cholesterol | 0 | % | |
| | Sterols | 1.63 | % | |
| | Di glycerides | 8.44 | % | |
| | Tri glycerides | 33.37 | % | |
| | Fatty acid | 1.07 | % | |
| | esters | | | |
| | Unidentified | 1.20 | % | |

Composition in fatty acids (NF EN ISO 12966-2)

| | FATTY ACID | Usual name | % |
|---|---|---|---|
| | C10:0 | Capric Acid | 0.1 |
| | C16:0 | Palmitic acid | 11.3 |
| | C18:0 | Stearic Acid | 2.5 |
| C18:1 trans | | | 1.2 |
| | C18:1 cis | Oleic Acid | 68.3 |
| C18:2 trans | | | 0.1 |
| | C18:2 cis | Linoleic Acid | 10.8 |
| | C18:3 cis | Linolenic Acid | 0.6 |
| | C20:0 | Arachidic Acid | 0.4 |
| | C20:1 | Eicosenoic Acid | 0.4 |
| | C24:0 | Lignoceric Acid | 0.1 |

| | |
|---|---|
| unidentified | 4.3 |

5) Sunflower oil condensate: composition of an example of a batch of sunflower oil condensate

| Analysis | Results | | Unit | Method |
|---|---|---|---|---|
| Acid index | 187.7 | | mg KOH/g | NF EN ISO |
| | | | | 660 |
| Saponification | 194 | | mg KOH/g | NF EN ISO |
| index | | | | 3657 |
| Fatty acid | 93.6 | | g/100 g of | NF EN ISO |
| content | | | product | 12966-2 |
| Glyceride | Free fatty | 98.9 | % | IUPAC |
| composition | acids | | | 6.002 and |
| | Mono | 0 | % | NF EN |
| | glycerides | | | 14105 |
| | Cholesterol | 0 | % | |
| | Sterols | 0.9 | % | |
| | Di glycerides | 0 | % | |
| | Tri glycerides | 0 | % | |
| | Fatty acid | 0 | % | |
| | esters | | | |
| | Unidentified | 0.3 | % | |

Composition in fatty acids (NF EN ISO 12966-2) batch E14-9234

| | FATTY ACID | Usual name | % |
|---|---|---|---|
| | C12:0 | Lauric acid | 0.2 |
| | C14:0 | Myristic acid | 0.1 |
| | C16:0 | Palmitic acid | 8.4 |
| | C16:1 | Palmitoleic acid | 0.2 |
| C17:1 | | | <0.1 |
| | C18:0 | Stearic Acid | 3.9 |
| | C18:1 cis | Oleic Acid | 26.6 |
| | C18:2 cis | Linoleic Acid | 56.6 |
| | C18:3 cis | Linolenic Acid | 0.2 |
| | C20:0 | Arachidic Acid | 0.3 |
| | C20:1 | Eicosenoic Acid | 0.2 |
| | C22:0 | Behenic Acid | 0.4 |
| | C24:0 | Lignoceric Acid | 0.1 |

6) Carrying out of mixtures and measurements of the mechanical and thermal properties of the polymer

Additivated granulates were carried out using polylactide and polylactic acid (PLA) and additive (chosen from an olive oil, soy, rapeseed or palm deodorization condensate,) via a method of granulation extrusion via the use of a conventional two-screw extruder provided with interpenetrated co-rotating co-driving screws. Such a method allows for the obtaining of additivated PLA granulates containing an average additive content that is known and controlled. In this particular case, the PLA was additivated with mass proportions in additives ranging from 5 to 20% by weight of additive with respect to the total weight of the additivated PLA.

For the purposes of comparison, PLA additivated with mass proportions of plasticizing additive known in prior art consisting of ATBC (acetyl tributyl citrate), DOA (Dioctyl Adipate) or PEG (polyethylene glycol) 400 ranging from 5 to 20% were also carried out.

The measurements of mechanical properties: breaking elongation, Young's modulus and yield stress were carried out according to the standard ISO 527-2, describing in particular the use of shouldered specimens of the 5A type of a thickness of about 1 mm; a prior conditioning before study of 72 h at 23° C. under 50% relative humidity; a traction speed of 25 mm/min as well as a temperature of 23° C. and a relative humidity of 50% during the measurement. The values indicated (tables 1 and 2) correspond to the average values obtained over 10 trials.

The measurement of the glass transition temperature was carried out by the temperature modulated differential scanning calorimetry method (TMDSC), with a heating speed of 2° C./min, a temperature modulation amplitude of 0.318° C. and a modulation period of 60 s. The measurements are usually taken under a nitrogen atmosphere at 50 ml/min. The values indicated for the glass transition temperature (table 3) correspond to the average values obtained over three trials.

The measurements of the global migration rates of the compounds forming the vegetable oil deodorization condensates, in the foods concerned were taken according to the global migration tests of EU regulations (EU Regulation No. 10/2011 of the Commission of Jan. 14, 2011 concerning materials and objects made of plastic material intended to come into contact with items of food) for three food simulants.

The measurements of the mechanical properties and of the glass transition temperatures for the various additivated PLAs were taken on films (or plates) having a thickness of about 1 mm obtained via thermocompression of the additivated granulates. The measurements of the migration rates in simulants for food contact as well as Robinson tests characterizing the possible impact of the packaging material on the organoleptic perception of the food were carried out on films having a thickness of about 50 μm obtained via single-screw extrusion with flat die then calendering of the additivated granulates.

For the additivated PLA with the sunflower condensate, the PLA condensate mixture (10%) was carried out in a two-screw extruder (PTW 16/40D Thermo Haake). The granulates were then thermo-compressed in order to obtain plates (Thermocompression with Gibrite press).

A heat-compressed plate was carried out and on this plate 4 specimens of the 5A type were cut in order to carry out the traction tests according to standard ISO 527-2.

The traction test is carried out on an Instron 4507, with a traction cell of 5 kN. The speed of traction for all of the trials is 5 mm/min.

Results:

1) Effect of the additivation with a deodorization condensate on the mechanical properties of the PLA

TABLE 1

| Ductility PLA (breaking elongation) - ISO 527-2 - | | | | | |
|---|---|---|---|---|---|
| 25 mm/min | | | | | |
| | Palm | Olive | Soy | Rapeseed | Sunflower |
| | conden- | conden- | conden- | conden- | conden- |
| | sate | sate | sate | sate | sate |
| | Average | Average | Average | Average | Average |
| | (%) | (%) | (%) | (%) | (%) |
| 0% | 6 | 5 | 6 | 5 | 6.4 |
| additive | | | | | |
| by | | | | | |
| weight | | | | | |
| 5% | 51 | 50 | 30 | 23 | — |
| additive | | | | | |
| by | | | | | |
| weight | | | | | |
| 10% | 132 | 85 | 73 | 56 | 100 |
| additive | | | | | |
| by | | | | | |
| weight | | | | | |
| 15% | 179 | 88 | 79 | 66 | — |
| additive | | | | | |
| by | | | | | |
| weight | | | | | |
| 20% | 84 | 67 | 52 | 73 | — |
| additive | | | | | |
| by | | | | | |
| weight | | | | | |

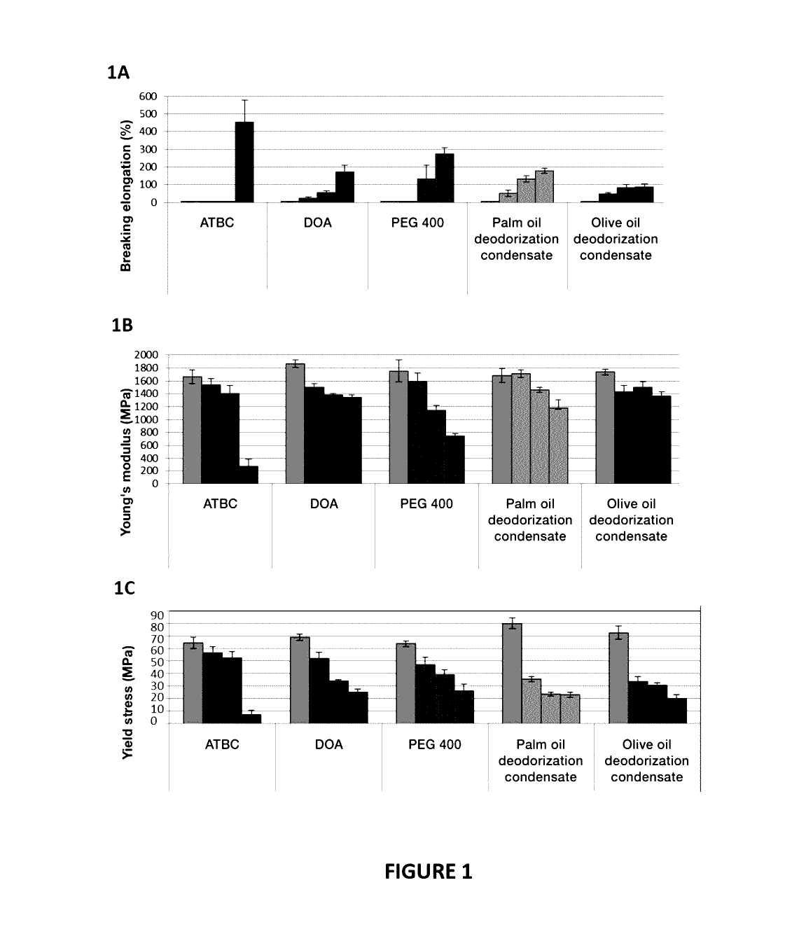

As shown in the table 1, as well as in FIG. 1A, the adding of a mass proportion of vegetable oil deodorization condensate ranging from 5 to 15% makes it possible to increase the breaking elongation of the PLA by a factor of 4 on the average, for a mass proportion of 5% of rapeseed condensate by a factor of 30 for a mass proportion of 15% of palm oil deodorization condensate, i.e. breaking elongation values from 22 to 178%. Regardless of the vegetable oil used, the use of a vegetable oil deodorization condensate in mass proportions from 10 to 15% makes it possible to obtain an increase in the breaking elongation of the PLA at least multiplied by 6, even multiplied by 10, in relation to non-additivated PLA with a deodorization condensate, i.e. a value for breaking elongation for the additivated PLA with a deodorization condensate at least equal to 40%, even 55%.

The use of vegetable oil condensates containing a substantial content in fatty acids (in particular greater than 70%) and in particular in free fatty acids (in particular greater than 35%) makes it possible to improve the plasticizing effectiveness of the condensate and in particular the effect of increasing the effect on the breaking elongation of the polymer. The palm oil condensate containing a proportion of fatty acids close to 100% and a content in free fatty acids of about 95% as such makes it possible to obtain the best effects with increases in the ductility of the PLA ranging from 10 to about 30 times for mass proportions of 5 or 15%.

As such the invention makes it possible to obtain additivated PLA, of which the breaking elongation is at least equal to 20%, in particular greater than 50 or 60% for mass proportions of additive ranging from 10 to 15%. The use of a palm oil deodorization condensate in mass proportions from 10 to 15% makes it possible in particular to obtain a breaking elongation at least equal to 50% even greater than 130%.

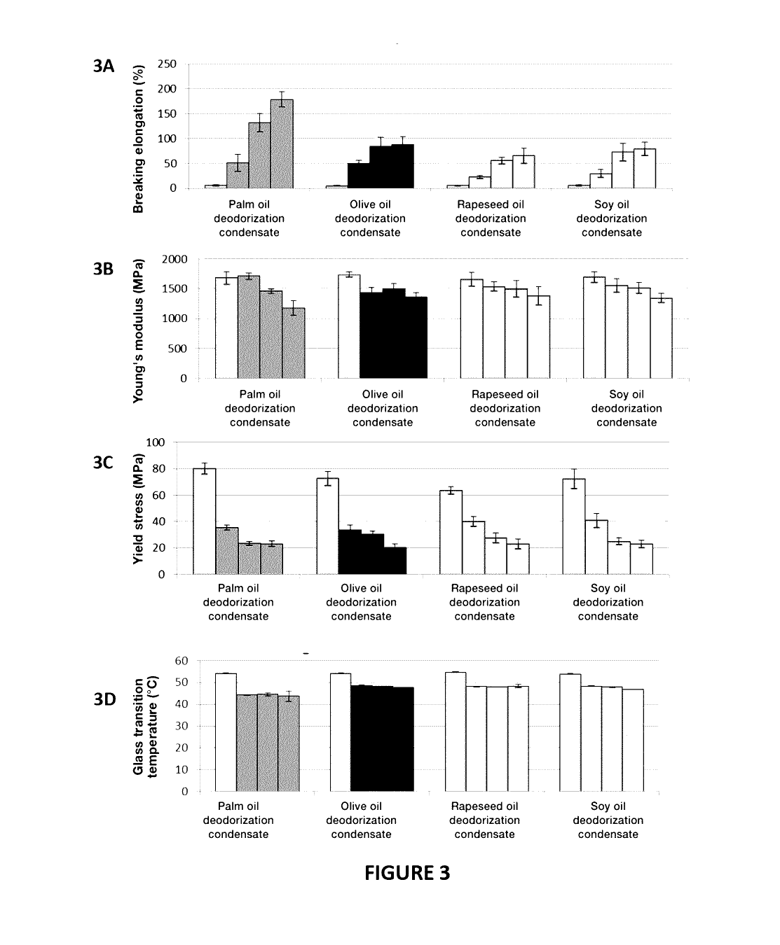

FIG. 1 also makes it possible to show that the use of vegetable oil deodorization condensates and in particular of palm oil or olive oil, and more particularly palm oil deodorization condensate, makes it possible to obtain results on the increase of the breaking elongation of the PLA, of the same magnitude as those obtained with a conventional plasticizer such as DOA (Dioctyl Adipate) (see FIG. 3A). Palm oil deodorization condensate makes it possible to obtain a more substantial increase in the breaking elongation for lower mass proportions, in particular for a mass proportion of 10%. The PEG 400 is actually effective on the increase in ductility only for mass proportions of 10 or 15%. Finally ATBC, a biodegradable and relatively non-toxic plasticizer, used in particular in nail polishes, makes it possible to obtain a breaking elongation greater than 300% but it induces a significant effect only for a minimum mass proportion of about 15%.

TABLE 2
Young's modulus PLAS - ISO 527-2 25 mm/min

| | Palm | Olive | Soy | Rapeseed |
|---|---|---|---|---|
| | condensate | condensate | condensate | condensate |
| | Average | Average | Average | Average |
| | (Mpa) | (Mpa) | (Mpa) | (Mpa) |
| 0% | 1680 | 1738 | 1694 | 1658 |
| additive | | | | |
| by | | | | |
| weight | | | | |
| 5% | 1713 | 1430 | 1550 | 1536 |
| additive | | | | |
| by | | | | |
| weight | | | | |
| 10% | 1458 | 1495 | 1516 | 1494 |
| additive | | | | |
| by | | | | |
| weight | | | | |
| 15% | 1179 | 1360 | 1344 | 1380 |
| additive | | | | |
| by | | | | |
| weight | | | | |
| 20% | 1133 | 1374 | 1216 | 1267 |
| additive | | | | |
| by | | | | |
| weight | | | | |

TABLE 3

| | | (PLA4060D + |
|---|---|---|
| | PLA4060D | 10% wt) (Average) |
| E (MPa) | 1518 | 1307 |
| σ_{E} (MPa) | 56.6 | 20.9 |
| A_{E} (%) | 4.8 | 2.3 |
| σ_{R} (MPa) | 50.7 | 20.0 |
| A_{R} (%) | 6.4 | 100.3 |

The analysis of the other mechanical properties of the PLA mixed with variable proportions of additives (see table 2 hereinabove) shows that the use of a vegetable oil deodorization condensate according to the invention makes it possible to maintain the values of Young's modulus (see also FIGS. 1B and 3B). Indeed, regardless of the vegetable oil used, the use of a vegetable oil deodorization condensate in order to increase the ductility of the PLA does not decrease Young's modulus by more than about 35%. In particular, for mass proportions of additive ranging from 5 to 15%, vegetable oil deodorization condensates reduce Young's modulus by less than 30% and makes it possible to obtain a mixture of additivated PLA of which Young's modulus is greater than 1200 MPa.

The results of table 3, obtained with additivated PLA by a sunflower oil deodorization condensate, have the same conclusions. The use of a sunflower oil deodorization condensate, in order to increase the ductility of the PLA does not decrease Young's modulus by more than about 20% and makes it possible to obtain a mixture of additivated PLA of which Young's modulus is greater than 1300 MPA.

FIG. 1B shows that only DOA makes it possible to maintain the value of Young's modulus, for mass proportions wherein these additives are effective. Indeed, ATBC produces a significant increase in the ductility only for a mass proportion at least equal to 15%, a proportion at which it indices a drastic decrease in Young's modulus for PLA.

FIG. 1C shows that the use of deodorization condensates according to the invention, and in particular of olive oil and palm oil deodorization condensate makes it possible to obtain additivated PLA of which the yield stress is greater than 20 MPa for mass proportions of additives ranging from 5 to 15%. For mass proportions of 10 or 15%, the values of yield stress for the additivated PLA with the vegetable oil deodorization condensates of the invention are similar to those obtained with DOA or PEG 400. The ATBC makes it possible to obtain a PLA additivated with a yield stress greater than 50 MPa for mass proportions of 5 or 10%. As indicated hereinabove, for a mass proportion of 15%, effective on the increase of the ductility (breaking elongation), the yield stress of the additivated PLA is less than 10 MPa. These results are similar regardless of the vegetable oil from which the vegetable oil deodorization condensate is obtained (FIG. 3C).

2) Effect of the additivation with a vegetable oil condensate on the thermal properties of the PLA

TABLE 4
Glass Transition Temperature PLA - TM-DSC 2° C. min

| | Palm | Olive | Soy | Rapeseed |
|---|---|---|---|---|
| | condensate | condensate | condensate | condensate |
| | Average | Average | Average | Average |
| | (° C.) | (° C.) | (° C.) | (° C.) |
| 0% | 54.7 | 55.4 | 55.1 | 55.3 |
| additive | | | | |
| by | | | | |
| weight | | | | |
| 5% | 50.2 | 49.6 | 51.4 | 51.8 |
| additive | | | | |
| by | | | | |
| weight | | | | |
| 10% | 49.4 | 49.4 | 49.7 | 49.7 |
| additive | | | | |
| by | | | | |
| weight | | | | |
| 15% | 49.1 | 48.7 | 49.5 | 49.1 |
| additive | | | | |
| by | | | | |
| weight | | | | |
| 20% | 49 | 48.8 | 48 | 48.6 |
| additive | | | | |
| by | | | | |
| weight | | | | |

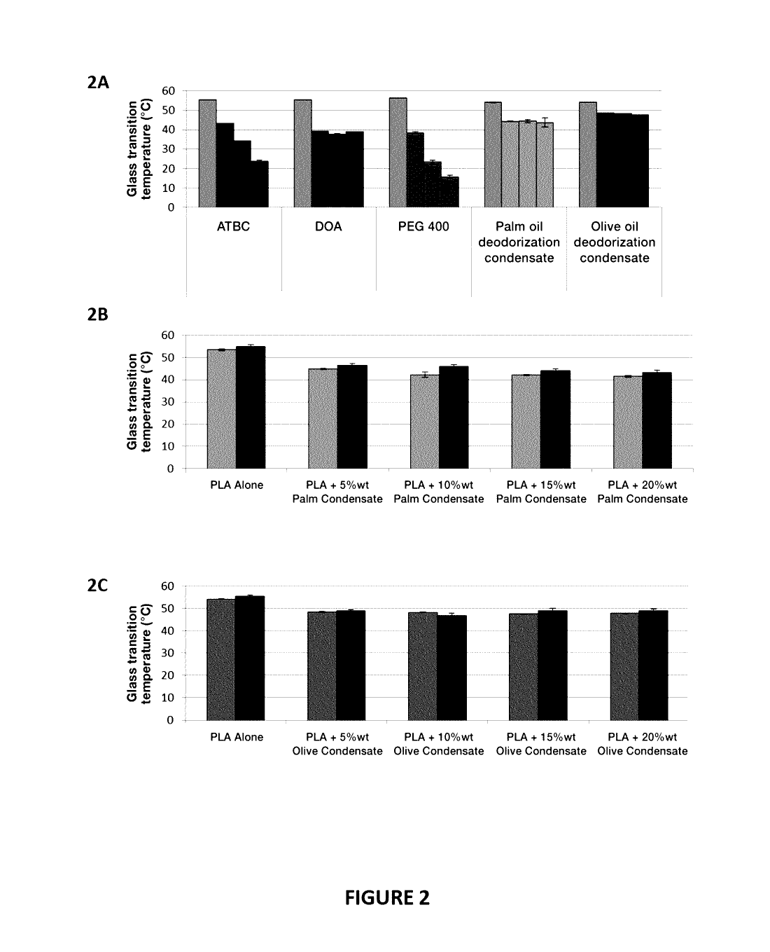

As shown in table 4, as well as in FIG. 2A, the use of vegetable oil deodorization condensate makes it possible to obtain additivated PLA of which the breaking elongation is at least equal to 20% (see table 1) and of which the glass transition temperature (Tg) is greater than 48° C. These values are compatible with a use as food packaging, in particular as a plastic bag and make it possible in particular to prevent the softening of the packaging carried out using additivated PLA according to the invention, at normal temperatures of use (conventionally less than 40° C.).

During the additivation of the PLA with a sunflower condensate, in a mass proportion of 10%, a value of glass transition temperature Tg similar to that of palm, olive, rapeseed or soy condensates is obtained. This value varies between 48 and 52° C. according to the batch of condensate used.

On the other hand, as shown in FIG. 2A, PLA additivated with plasticizing additives of prior art has a glass transition temperature less than 40° C., for proportions of additives of 5, 10 or 15%. As such PLA additivated with a mass proportion of 15% of ATBC, a biodegradable and non-toxic plasticizer, has a Tg less than 25° C. The additivated PLA of DOA, a conventional plasticizer with an adipate base, in proportions of 5, 10 or 15% has a Tg less than 40° C. Finally the additivated PLA of PEG 400 in a mass proportion of 15%, has a Tg less than 20° C. These results are similar regardless of the vegetable oil from which the vegetable oil deodorization condensate is obtained (FIG. 3D)

The stability of the additivated PLA granulates of olive or palm oil deodorization condensate, shown by the glass transition temperature, was compared to 20 days and 170 or 290 days, as shown in FIGS. 2B and 2C.

The results show that the glass transition temperature is not modified over this period, and regardless of the vegetable oil (palm or olive) and the mass proportion of vegetable oil deodorization condensate added to the PLA (from 5 to 15%).

Finally, the results of the global migration tests carried out on the films of additivated PLA from 5 to 10% by weight of palm oil deodorization condensates show that the total concentration in compounds forming said condensates in food simulant environments is less than the regulatory migration threshold, i.e. 60 mg/kg of food simulant. Such results predict a stability of the film carried out in additivated PLA according to the invention with food contact for one year, at ambient temperature.

Furthermore, regulations in terms of food packaging impose a non-alteration of the olfactory and organoleptic properties of the food with contact. A Robinson test, conducted on a panel of persons on the films of additivated PLA of 5 and 10% by weight in palm oil deodorization condensate did not reveal any alteration on the taste or in the odor.

All of these results show that PLA additivated with a deodorization condensate globally has mechanical properties and a glass transition temperature higher than PLA mixed with additives known in prior art. All of these qualities make it possible to obtain a biosourced and biodegradable plastic material that can be used as packaging, in particular for food.

3) Synergistic effect of a deodorization condensate on the improvement of the ductility of the PLA

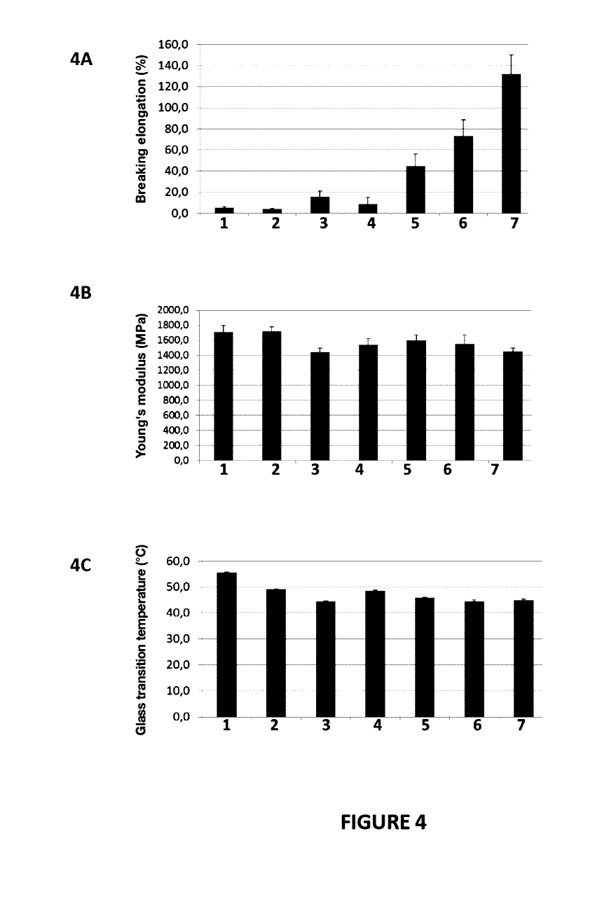

The comparison of different compositions of free fatty acids shows also that a vegetable oil deodorization condensate induces a superior effect on the increase in the ductility of the polymer with respect to a simple mixture of fatty acids that it is comprised of. These results (see table 4 hereinbelow and FIG. 4 A-C) strongly suggest a synergistic effect of the various compounds of the condensate with respect to the mixture of free fatty acids.

For the purposes of this comparison, 7 compositions were prepared. For compositions 2 to 7, 10% by weight of additive were added, with respect to the total weight of the composition, were added to PLA4060D. The composition 1 corresponds to PLA4060D without additive.

composition 1: PLA4060D

composition 2: PLA4060D+10% palmitic acid (100%)

composition 3: PLA4060D+10% oleic acid (100%)

composition 4: PLA4060D+10% Hydrogenated palm oil [10% diglycerides (DG)+90% triglycerides (TG) such as estimated according to the method described in standard NFEN 14105]

composition 5: PLA4060D+10% [50% wt palmitic acid+50% wt oleic acid]

composition 6: PLA4060D+10% [95% wt mixture of free fatty acids (50% wt palmitic acid+50% wt Oleic acid)+5% wt hydrogenated palm oil (10% DG+90% TG]

composition 7: PLA4060D+10% Palm oil deodorization condensate [95.4% of free fatty acids (of which 49.8% palmitic acid+35% oleic acid+7.7% linoleic acid+4.1% stearic acid+1.3% Myristic acid+others) and 4.6% of glycerides (of which 1.7% monoglycerides (MG)+2.2% DG+0.7% triglycerides TG)].

TABLE 5

| COMPOSITION | 1 | 2 | 3 | 4 | 5 | 6 | 7 |
|---|---|---|---|---|---|---|---|
| Breaking | 5 | 4 | 16 | 9 | 45 | 74 | 132 |
| elongation (%) | | | | | | | |
| Young's | 1709 | 1722 | 1440 | 1540 | 1593 | 1549 | 1458 |
| Modulus (MPa) | | | | | | | |
| Glass transition | 55.7 | 49.0 | 44.6 | 48.6 | 45.9 | 44.6 | 44.9 |
| temperature | | | | | | | |
| (° C.) | | | | | | | |

The mechanical properties were measured according to the methods and standards defined hereinabove. The glass transition temperature was measured by non-modulated DSC (Differential Scanning calorimetry), with a heating speed of 10° C./min.

The results show that for this example, the adding in the composition of a mixture constituted of a saturated free fatty acid (palmitic acid) and of an unsaturated free fatty acid (oleic acid) makes it possible to obtain an increase by a factor of 10 of the breaking elongation. Such a mixture represents about 80% of the composition of a palm oil deodorization condensate. The closer the mixture used is to the final composition of the palm oil condensate, the more substantial the increase in the breaking elongation observed is. As such PLA additivated with the composition 6, which has about 85% of similarity of composition with the palm oil deodorization condensate, has an increase in the breaking elongation of more than 10 times with respect to the control PLA (composition 1). The use of the palm oil deodorization condensate makes it possible to obtain the best result, i.e. a breaking elongation for the PLA of about 130% i.e. an increase by practically a factor of 25. These results demonstrate the superiority of the natural deodorization condensate of complex composition concerning the improvement in the ductility, compared to the isolated use of a type of molecules present in the natural product. The cocktail/synergistic effect between the various organic molecules naturally present appears to be a determining factor.

The composition of the additive (composition 2 to 7) does not significantly modify the glass transition temperature and Young's modulus.

4) Variability of the batches of palm condensate on the mechanical and thermal properties of PLA

The composition of a deodorization condensate of a given oil is able to vary according to the batches. As shown hereinbelow the variability between the various batches does not modify the results obtained with regards to the mechanical and thermal properties of the additivated polymer obtained.

CP1=Palm Condensate of the 1st batch (E 12-1822)

CP2=Palm Condensate of the 2nd batch (E 14-5299)

CP3=Palm Condensate of the 3rd batch (E 14-5903)

Composition of the palm deodorization condensate batch E12-1822

| Analysis | Results | | Unit | Method |
|---|---|---|---|---|
| Acid index | 201 | | mg KOH/g | NF EN ISO |
| | | | | 660 |
| Saponification | 205.7 | | mg KOH/g | NF EN ISO |
| index | | | | 3657 |
| Fatty acid | 100 | | g/100 g of | NF EN ISO |
| content | | | product | 12966-2 |
| Glyceride | Free fatty | 95.3 | % | IUPAC |
| composition | acids | | | 6.002 and |
| | Mono | 1.7 | % | NF EN |
| | glycerides | | | 14105 |
| | Cholesterol | 0 | % | |
| | Sterols | 0 | % | |
| | Di glycerides | 2.2 | % | |
| | Tri glycerides | 0.7 | % | |
| | Fatty acid | 0 | % | |
| | esters | | | |
| | Unidentified | 0 | % | |

Composition in fatty acids (NF EN ISO 12966-2) batch E12-1822

| FATTY ACID | Usual name | % |
|---|---|---|
| C8:0 | Caprylic Acid | <0.1 |
| C10:0 | Capric Acid | <0.1 |
| C12:0 | Lauric acid | 0.4 |
| C14:0 | Myristic acid | 1.3 |
| C16:0 | Palmitic acid | 49.8 |
| C16:1 | Palmitoleic acid | 0.2 |
| C17:1 | | <0.1 |
| C18:0 | Stearic Acid | 4.1 |
| C18:1 trans | | 0.2 |
| C18:1 cis | Oleic Acid | 35 |
| C18:2 trans | | 0.1 |
| C18:2 cis | Linoleic Acid | 7.7 |
| C18:3 trans | | <0.1 |
| C18:3 cis | Linolenic Acid | 0.3 |
| C20:0 | Arachidic Acid | 0.3 |
| C20:1 | Eicosenoic Acid | 0.1 |
| C22:0 | Behenic Acid | 0.1 |
| C24:0 | Lignoceric Acid | <0.1 |

| | |
|---|---|
| unidentified | 0.7 |

Composition palm oil deodorization condensate E14-5299

| Analysis | Results | | Unit | Method |
|---|---|---|---|---|
| Acid index | 187.8 | | mg KOH/g | NF EN ISO |
| | | | | 660 |
| Saponification | 202 | | mg KOH/g | NF EN ISO |
| index | | | | 3657 |
| Fatty acid | 100 | | g/100 g of | NF EN ISO |
| content | | | product | 12966-2 |
| Glyceride | Free fatty | 96 | % | IUPAC |
| composition | acids | | | 6.002 and |
| | Mono | 1.3 | % | NF EN |
| | glycerides | | | 14105 |
| | Cholesterol | 0 | % | |
| | Sterols | 0.9 | % | |
| | Di glycerides | 2 | % | |
| | Tri glycerides | 0.4 | % | |
| | Fatty acid | 0 | % | |
| | esters | | | |
| | Unidentified | 0.3 | % | |

Composition in fatty acids (NF EN ISO 12966-2)

| FATTY ACID | Usual name | % |
|---|---|---|
| C8:0 | Caprylic Acid | <0.1 |
| C10:0 | Capric Acid | <0.1 |
| C12:0 | Lauric acid | 0.2 |
| C14:0 | Myristic acid | 1.1 |
| C16:0 | Palmitic acid | 46.4 |
| C16:1 | Palmitoleic acid | 0.2 |
| C17:1 | | <0.1 |
| C18:0 | Stearic Acid | 4.3 |
| C18:1 trans | | 0.1 |
| C18:1 cis | Oleic Acid | 37.6 |
| C18:2 trans | | 0.1 |
| C18:2 cis | Linoleic Acid | 8.9 |
| C18:3 trans | | <0.1 |
| C18:3 cis | Linolenic Acid | 0.4 |
| C20:0 | Arachidic Acid | 0.3 |
| C20:1 | Eicosenoic Acid | 0.1 |
| C22:0 | Behenic Acid | 0.1 |
| C24:0 | Lignoceric Acid | <0.1 |

| | |
|---|---|
| unidentified | <0.1 |

Composition palm oil deodorization condensate E14-5903

| Analysis | Results | | Unit | Method |
|---|---|---|---|---|
| Acid index | 181.9 | | mg KOH/g | NF EN ISO |
| | | | | 660 |
| Saponification | 206 | | mg KOH/g | NF EN ISO |
| index | | | | 3657 |
| Fatty acid | 99.8 | | g/100 g of | NF EN ISO |
| content | | | product | 12966-2 |
| Glyceride | Free fatty | 93.3 | % | IUPAC |
| composition | acids | | | 6.002 and |
| | Mono | 3.0 | % | NF EN |
| | glycerides | | | 14105 |
| | Cholesterol | 0 | % | |
| | Sterols | 0 | % | |
| | Di glycerides | 3.2 | % | |
| | Tri glycerides | 0.4 | % | |
| | Fatty acid | 0 | % | |
| | esters | | | |
| | Unidentified | 0.1 | % | |

Composition in fatty acids (NF EN ISO 12966-2)

| FATTY ACID | Usual name | % |
|---|---|---|
| C8:0 | Caprylic Acid | 0.1 |
| C10:0 | Capric Acid | 0.1 |
| C12:0 | Lauric acid | 0.8 |
| C14:0 | Myristic acid | 1.4 |
| C16:0 | Palmitic acid | 50.6 |
| C16:1 | Palmitoleic acid | 0.2 |
| C17:1 | | <0.1 |
| C18:0 | Stearic Acid | 4.1 |
| C18:1 trans | | 0.2 |
| C18:1 cis | Oleic Acid | 32.9 |
| C18:2 trans | | 0.1 |
| C18:2 cis | Linoleic Acid | 8.5 |
| C18:3 trans | | <0.1 |
| C18:3 cis | Linolenic Acid | 0.3 |
| C20:0 | Arachidic Acid | 0.3 |
| C20:1 | Eicosenoic Acid | 0.1 |
| C22:0 | Behenic Acid | 0.1 |
| C24:0 | Lignoceric Acid | <0.1 |

| | |
|---|---|
| unidentified | <0.1 |

Conditions for implementation and testing

Mixtures carried out with a two-screw extruder PTW 16-40D Thermo Haake®

The granulates are then thermocompressed in order to obtain plates. (Thermocompression on Gibrite press). Carrying out of several thermocompressed plates and on each plate several specimens of the 5A type were cut in order to carry out the tests of traction according to the standard ISO 527-2⁽²⁾.

Traction test: Instron 4301 of the PIMM, with a traction cell of 5 kN of the CNAM. The traction speed for all of the trials is 5 mm/min

Results:

The results of the mechanical properties of the additivated PLAs with the three batches of palm condensates are shown in Table 6 hereinbelow.

For the two mixtures CP2 and CP3, the traction specimens were cut in three plates carried out with the same parameters for thermocompression.

TABLE 6

| | | | CP1 | CP2 | CP3 |
|---|---|---|---|---|---|
| Composition | Glycerides | Free fatty acids | 95.37 | 96 | 93.3 |
| (% wt) | | Mono glycerides | 1.66 | 1.3 | 3 |
| | | Di glycerides | 2.24 | 2 | 3.2 |
| | | Tri glycerides | 0.65 | 0.4 | 0.4 |
| | Fatty | Palmitic acid | 49.8 | 46.4 | 50.6 |
| | acids | Oleic Acid | 35 | 37.6 | 32.9 |
| | | Linoleic Acid | 7.7 | 8.9 | 8.5 |
| | | Stearic Acid | 4.1 | 4.3 | 4.1 |

| Mechanical | E (MPa) | 1460 | 1210 | 1300 |
|---|---|---|---|---|
| properties | σ_{E} (MPa) | 24 | 19.4 | 21.6 |
| | A_{E} (%) | 2.1 | 1.9 | 2.1 |
| | σ_{R} (MPa) | — | 17.5 | 18.9 |
| | A_{R} (%) | 132.0 | 113.6 | 117.1 |

5) Thermal properties of the PLA: variability of the batches of palm condensate

The characteristics of the mixtures were determined using the DSC TA Q1000®. The method used for all of the samples was as follows:

A first heating at 10° C./min to 120° C.

An isotherm at 120° C. for 2 minutes

A cooling at 10° C./min to −50° C.

An isotherm at −50° C. for 2 minutes

A second heating at 10° C./min to 120° C.

TABLE 7
Thermal properties (glass transition Tg) of the PLA in the presence
of the various batches of palm deodorization condensates.

| PLA/additive | Tg (° C.) |
|---|---|
| PLA4060D + 10% wt CP1 * | 49.4 |
| PLA4060D + 10% wt CP2 | 38.3 |
| PLA4060D + 10% wt CP3 | 40.1 |

Table 7 shows that the variability in the composition of the batches of palm condensates does not affect the value of the glass transition temperature of the additivated PLA. This temperature is lowered slightly by the adding of vegetable oil deodorization condensate and as such remains above ambient temperature.

6) Polymer material: mixture of PLA4060D 90%+PHBV 10%

Conditions for implementation and testing

The mixtures of PLA4060D with 10% CP1 then with PHBV 10%, were obtained in a two-screw extruder or as a dry blend mixture then the films were produced via cast extrusion or via blow-film extrusion with extruder MAPRE 30-33D.

On the films produced, traction specimens were cut using a punch. These are standardized specimens of the 5A type according to the standard ISO 527-2⁽²⁾.

Traction test: Instron 4507, with a traction cell of 5 kN of the CNAM. The traction speed for all of the trials is 5 mm/min

Results

TABLE 8
Mechanical properties of the films of mixtures PLA + 10%
PHBV additivated with 10% of palm oil deodorization condensate
(CP1) produced via cast extrusion and blow-film extrusion

| | E (MPa) | A_{R} (%) |
|---|---|---|
| PLA4060D + 10% PHBV Extrusion cast | 1640 | 16 |
| PLA4060D + 10% CP1 Blow-film extrusion | 2226 | 87 |
| (90 PLA4060 + 10 CP1) + PHBV | 2032 | 112 |
| Dry blend + Extrusion cast | | |
| (90 PLA4060 + 10 CP1) + PHBV | 1410 | 132 |
| Dry blend + Blow-film extrusion | | |
| (90 PLA4060 + 10 CP1) + PHBV | 1086 | 78 |
| Two-screw + Extrusion cast | | |
| (90 PLA4060 + 10 CP1) + PHBV | 2560 | 128 |
| Two-screw + Blow-film extrusion | | |

The virgin PLA4060D can be formed via cast extrusion but cannot be formed by blow-film extrusion due to its low melt strength. Indeed, the values of A_{R} for a virgin PLA vary between 5 and 9% for a film obtained as cast extrusion or via thermocompression.

The results of Table 8 confirm the improvement of the properties of breaking deformation for a film of PLA +10% CP product either by blow-film extrusion or by cast extrusion. The values of A_{R} (breaking elongation) vary between 87% and 141%,

As such only the adding of the vegetable oil condensate (here the CP) in the PLA, via its effect on the increase in ductility (increased breaking elongation), allows for the forming via blow-film extrusion. Via blow-film extrusion, the films coming from the mixture of (PLA+10% CP1) and of PHBV show breaking elongations that vary between 128 and 144%. An effect of the condensate on the mechanical properties, at ambient temperature, but also in melted state, is therefore observed.

7) Incorporation of the palm condensate in polyester other than PLA

PHB and PHBV

Two biosourced and biodegradable polyesters of the family of PHAs were tested for the incorporation of the palm oil condensate. This is PHB: Poly (3-hydroxybutyrate) and PHBV: Poly (3-hydroxybutyrate-co Hydroxyvalerate)

Conditions for Forming and Testing:

Mixtures carried out with internal mixer Haake with 10% palm condensate CP1

The granulates are then thermocompressed in order to obtain plates. (Thermocompression Gibrite of the PIMM). A heat-compressed plate was manufactured on each mixture and several specimens of the 5A type were cut on the plate in order to conduct the traction tests.

Traction test: Instron 4507 of the CNAM, with a traction cell of 5 kN of the CNAM.

The traction speed for all of the trials is 5 mm/min

Results

TABLE 9
Mechanical properties of the two grades of virgin
and additivated PHB and PHBV with the palm oil
deodorization condensate (batch CP1) (n = 4)

| | |
|---|---|
| PHB (biomer 310 2013) | PHBV (PHI003) |

| | — | +10% wtCP1 | — | +10% wtCP1 |
|---|---|---|---|---|
| E (MPa) | 900 | 599 | 835 | 785 |
| σ_{E} (MPa) | 30.3 | 20.4 | 18.5 | 16.9 |
| A_{E} (%) | 6.0 | 6.0 | 2.4 | 3.2 |
| σ_{R} (MPa) | 30.2 | 20.0 | 18.3 | 15.9 |
| A_{R} (%) | 6.1 | 6.2 | 2.5 | 4.6 |

The PHA of grade PHI003 (PHBV) shows a very slight reduction in Young's modulus and an increase of the breaking elongation of 86% (increase by at least a factor of 1.5).

PHB shows on the contrary a maintaining of the breaking elongation and a significant decrease in Young's modulus by at least 30%. Such a modification of the properties of the additivated polymer makes it possible to obtain a more flexible material of which the processability is improved.

Polyamide

Conditions for Implementation and Testing:

A mixture of PA11 and of 10% of palm condensate (CP1) was manufactured by internal mixer. The granulates were then thermocompressed, and specimens were cut using these plates. The traction tests were carried out on Instron 4507 of the Cnam with a traction cell of 5 KN. The traction speed is 5 mm/min

Results:

TABLE 10
mechanical properties and glass transition temperature (Tg) of
the PA11 in the presence of a palm oil deodorization condensate

| | PA11 | (PA11 + 10% wtCP1) |
|---|---|---|
| E (MPa) | 652 | 297 |
| σ_{E} (MPa) | 34.9 | 34.3 20 |
| A_{E} (%) | 8.9 | 74.6 |
| σ_{R} (MPa) | 40.7 | 40.8 |
| A_{R} (%) | 280 | 302 |
| Tg (° C.) | 50 | 30 |

An increase of 8% in the factor A_{R} (breaking elongation) of the additivated PA11 is measured with regards to the virgin PA11 (non-additivated). The glass transition of the PA11 is lowered to 30° C. with 10% of palm condensate. The results on PLA11 also show that Young's modulus (E) decreases by half, and that the 2 stresses σ_{E} (yield stress) and σ_{R} (breaking stress) do not vary. Finally a very significant increase, by a factor of 8, in the breaking elongation (A_{E}) is measured. This shows that the palm oil deodorization condensate makes it possible to increase the deformation to yield of the PA11, without decreasing the yield stress. Such a modification makes it possible to obtain a much more elastic material that makes it possible to consider applications in the fields that are usually covered by elastomers and rubbers, which are generally penalized by their low glass transition temperatures while in the case of the additivated PA11, the glass transition is beyond the ambient temperature.

1. F. Ali, Y.-W. Chang, S. C. Kang and J. Y. Yoon, Polymer Bulletin, 2009, 62, 91-98.

2. Y. Q. Xu and J. P. Qu, Journal of Applied Polymer Science, 2009, 112, 3185-3191.

3. Z. Xiong, Y. Yang, J. Feng, X. Zhang, C. Zhang, Z. Tang and J. Zhu, Carbohydr. Polym., 2012, 92, 810-816.

4. V. S. G. Silverajah, N. A. Ibrahim, N. Zainuddin, W. Yunus and H. Abu Hassan, Molécules, 2012, 17, 11729-11747.

5. V. S. G. Silverajah, N. A. Ibrahim, W. Yunus, H. Abu Hassan and C. B. Woei, Int. J. Mol. Sci., 2012, 13, 5878-5898.

6. E. A. J. Al-Mulla, W. Yunus, N. A. B. Ibrahim and M. Z. Ab Rahman, Journal of Materials Science, 2010, 45, 1942-1946.

1-15. (canceled)

16. Method for manufacturing an additivated thermoplastic polymer material which comprises a step of additivation at least one thermoplastic polymer material with a composition comprising at least one saturated free fatty acid and at least one unsaturated free fatty acid, as an additive, in order to modify the mechanical properties of said at least one thermoplastic polymer material.

17. Method according to claim 16, wherein the thermoplastic polymer material comprises at least one thermoplastic polymer chosen from poly(vinyl chloride), a polyamide or a polyester.

18. Method according to claim 17, wherein the polyester is a polyester from the family of polyethylene terephthalates or a biodegradable polyester.

19. Method according to claim 16, wherein the thermoplastic polymer material is polylactic acid, polylactide or one of the copolymers thereof.

20. Method according to claim 16, wherein the composition comprising at least one saturated free fatty acid and at least one unsaturated free fatty acid is comprised in a vegetable oil deodorization condensate.

21. Method according to claim 20, wherein the thermoplastic polymer material is additivated with a mass proportion of vegetable oil deodorization condensate ranging from 1 to 30%, preferentially from 5 to 15%, by weight with respect to the total weight of the additivated thermoplastic polymer material by said vegetable oil deodorization condensate.

22. Method according to claim 20, wherein the vegetable oil is chosen from soy oil, olive oil, palm oil, rapeseed oil, peanut oil, almond oil, sunflower oil, oleic sunflower oil, palm kernel oil, grape seed oil, pumpkin seed oil, corn oil, walnut oil, wheat germ oil, borage oil, hazelnut oil, cameline oil, hemp oil, macadamia oil, primrose oil.

23. Method according to claim 20, wherein the vegetable oil deodorization condensate is obtained during the step of deodorization of a method of physical or chemical refining of a vegetable oil, by distillation of fatty acids, with said vegetable oil being agitated with a quantity of injected steam ranging from 7.5 to 8.5 kg/h, at a temperature ranging from 180 to 260° C., and under an absolute pressure less than 5 mBar.

24. Method according to claim 23, wherein the vegetable oil deodorization condensate is obtained by physical refining at a temperature ranging from 240 to 260° C.

25. Method according to claim 20, wherein the vegetable oil deodorization condensate comprises a mass proportion of free fatty acids with respect to the total weight of the vegetable oil deodorization condensate ranging from 15 to 100%.

26. Additivated thermoplastic polymer material comprising at least one thermoplastic polymer chosen from poly(vinyl chloride), polyesters from the polyethylene terephthalate family and biodegradable polyesters, wherein the thermoplastic polymer is additivated by at least one vegetable oil deodorization condensate.

27. Additivated thermoplastic polymer material according to claim 26, wherein the thermoplastic polymer is a biodegradable material consisting of polylactic acid, polylactide and/or one of the copolymers thereof.

28. Additivated thermoplastic polymer material according to claim 27, wherein the mass proportion of the vegetable oil deodorization condensate with respect to the total weight of the additivated thermoplastic material ranges from 5 to 30%, with said material having the following mechanical properties, measured in uniaxial traction according to the standard ISO 527-2: a breaking elongation ranging from 30 to 300%, a Young's modulus greater than 1200 MPa, a yield stress greater than 15 MPa, said material further having a glass transition temperature, measured by TMDSC (temperature modulated differential scanning calorimetry) ranging from 45 to 55° C. at atmospheric pressure.

29. Food packaging carried out in an additivated thermoplastic polymer material according to claim 26.

30. Food packaging carried out in an additivated thermoplastic polymer material according to claim 27.

31. Food packaging carried out in an additivated thermoplastic polymer material according to claim 28.

32. Method for manufacturing an additivated thermoplastic polymer material according to claim 26, which comprises a step of additivation of at least one thermoplastic polymer material with a vegetable oil deodorization condensate.

33. Method for manufacturing an additivated thermoplastic polymer material according to claim 27, which comprises a step of additivation of at least one thermoplastic polymer material with a vegetable oil deodorization condensate.

34. Method for manufacturing an additivated thermoplastic polymer material according to claim 28, which comprises a step of additivation of at least one thermoplastic polymer material with a vegetable oil deodorization condensate.
